(19) United States
(12) Patent Application Publication
(10) Pub. No.: US 2017/0277750 A1
(43) Pub. Date: Sep. 28, 2017

(54) QUERYING BIG DATA BY ACCESSING SMALL DATA

(71) Applicant: Futurewei Technologies, Inc., Plano, TX (US)

(72) Inventors: Wenfei Fan, Edinburgh (GB); Yang Cao, Edinburgh (GB); Floris Geerts, Antwerpen (BE); Ting Deng, Beijing (CN); Ping Lu, Beijing (CN)

(73) Assignee: Futurewei Technologies, Inc., Plano, TX (US)

(21) Appl. No.: 15/082,396

(22) Filed: Mar. 28, 2016

(51) Int. Cl. G06F 17/30

(52) U.S. Cl. CPC G06F 17/30463; G06F 17/3051

(57) ABSTRACT

A processor executes instructions stored in non-transitory memory to determine whether a query to big data is bounded evaluable, or may be rewritten to access a bounded amount of data or information in a dataset. A query plan may retrieve the information by using indices in access constraints of the query. The cost associated with obtaining the information by using the query plan may be dependent on the query and access constraints and not the size of the dataset. A query plan to obtain the information may be formed for different types or classes of queries, such as conjunctive queries (CQ), unions of conjunctive queries (UCQ) and positive existential FO (first order) conjunctive queries (∃FO⁺). When a query is not bounded evaluable, a determination is made whether an approximation to the information may be retrieved. An approximation may be obtained by using upper and lower envelopes or specialized queries.

### BACKGROUND

Querying big data, or requesting particular information from a large amount of data in a dataset or database to obtain an answer may require a relatively fast device and still may take a relatively long amount of time. Querying big data of 10¹⁵ bytes of information to obtain an answer may take days using a solid state drive processor with a read speed of approximately 6 GB/s (Gigabytes/second). An answer to a query may take years using a similar processor when big data of information is a size of 10¹⁸ bytes.

Reducing an amount of time to obtain an answer to a query of big data while not increasing read speed of a solid state processor may result in search efficiency.

### SUMMARY

A processor executes instructions stored in non-transitory memory storage to determine whether a query to big data is bounded evaluable, or may be rewritten to access a bounded amount of data or information in a dataset. A rewritten query or plan may retrieve the information by using indices in access constraints of the query. The cost associated with obtaining the information by the rewritten query may be dependent on the query and the access constraints, and not the size of the dataset. A query plan to obtain the information may be formed for different types or classes of queries, such as conjunctive queries (CQ), unions of conjunctive queries (UCQ), or positive existential FO (first order) conjunctive queries (∃FO⁺; a.k.a. SPJU). When a query is not bounded evaluable, a determination is made whether an approximation to the information may be retrieved. An approximation may include upper and lower envelopes or specialized queries.

In one embodiment, the present technology relates to a device comprising a non-transitory memory storage having instructions and one or more processors in communication with the memory. The one or more processors execute the instructions to receive a query having a set of access constraints to retrieve information and determine a query type of the query. The one or more processors also executes instructions to determine whether the query is bounded evaluable under the set of access constraints and form a query plan to retrieve the information when the query is bounded evaluable under the set of access constraints. The one or more processors executes instructions to rewrite the query to a rewritten query using the query plan and retrieve the information in response to the rewritten query.

In another embodiment, the present technology relates to a computer-implemented method for retrieving data from a dataset. The computer-implemented method comprises receiving, with one or more processors, a first query to retrieve data from the dataset. A determination, with one or more processors, is made of a set of access constraints in the first query and indices in the set of access constraints in the first query. A second query is formed based on the indices in the first query and outputted to obtain the data in the dataset.

In a further embodiment, the present technology relates to a non-transitory computer-readable medium storing computer instructions, that when executed by one or more processors, cause the one or more processors to perform steps. A query is received having a set of access constraints to retrieve information from a dataset. A determination is made whether the query is bounded evaluable under the set of access constraints. The query is rewritten to a rewritten query using at least one access constraint in the set of access constraints when the query is bounded evaluable. The rewritten query is outputted to retrieve the information. A determination is made whether approximate information may be obtained when the query is not bounded evaluable.

This Summary is provided to introduce a selection of concepts in a simplified form that are further described below in the Detailed Description. This Summary and/or headings are not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagram illustrating retrieving information of a big data stored in memory according to an embodiment of the present technology.

FIGS. 2-4 are flowcharts that illustrate methods for querying big data to obtain a bounded amount of information according to embodiments of the present technology.

FIG. 5 is a flowchart that illustrates a method to determine whether a query is bounded evaluable (covered) under a set of access constraints for CQ using coverage checking according to embodiments of the present technology.

FIG. 6 is a flowchart that illustrates a method to determine whether a query is bounded evaluable (covered) under a set of access constraints for UCQ and ∃FO⁺ using coverage checking according to embodiments of the present technology.

FIG. 7 is a flowchart that illustrates generating a bounded evaluable query plan for covered queries according to embodiments of the present technology.

FIG. 8 is a flowchart that illustrates determining whether a bounded upper envelope approximation is obtainable for a CQ according to embodiments of the present technology.

FIG. 9 is a flowchart that illustrates determining whether a bounded upper envelope approximation is obtainable for a UCQ or ∃FO⁺ according to embodiments of the present technology.

FIG. 10 is a flowchart that illustrates determining whether a bounded lower envelope approximation is obtainable for a CQ or UCQ according to embodiments of the present technology.

FIG. 11 is a flowchart that illustrates determining whether a bounded lower envelope approximation is obtainable for a ∃FO⁺ according to embodiments of the present technology.

FIG. 12 is a flowchart that illustrates determining whether a specialized query is obtainable for a CQ according to embodiments of the present technology.

FIG. 13 is a flowchart that illustrates determining whether a specialized query is obtainable for a UCQ or ∃FO⁺ according to embodiments of the present technology.

FIG. 14 is a block diagram that illustrates a system architecture for querying big data to obtain a bounded amount of information according to embodiments of the present technology.

FIG. 15 is a block diagram that illustrates a computing device architecture for querying big data to obtain a bounded amount of information according to embodiments of the present technology.

FIG. 16 is a block diagram that illustrates a software architecture for querying big data to obtain a bounded amount of information according to embodiments of the present technology.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The present technology, roughly described, relates to retrieving information from big data, including datasets that are very large or complex. A processor executes instructions stored in non-transitory memory storage to determine whether a query to big data is bounded evaluable, or may be rewritten to access a bounded amount of data or information in a dataset. A plan or rewritten one or more queries may retrieve the information by using indices in access constraints of the query. The cost associated with obtaining the information by the rewritten query may be dependent on the query and Q_{BE}, access constraints, and not the size of the dataset. A query plan to obtain the information may be formed for different types or classes of queries, such as conjunctive queries (CQ), unions of conjunctive queries (UCQ) and positive existential FO (first order) conjunctive queries (∃FO⁺). When a query is not bounded evaluable, a determination is made whether an approximation to the information may be retrieved. An approximation may be obtained using upper and lower envelopes or specialized queries.

It is understood that the present technology may be embodied in many different forms and should not be construed as being limited to the embodiments set forth herein. Rather, these embodiments are provided so that this disclosure will be thoroughly and completely understood. Indeed, the disclosure is intended to cover alternatives, modifications and equivalents of these embodiments, which are included within the scope and spirit of the disclosure as defined by the appended claims. Furthermore, in the following detailed description, numerous specific details are set forth in order to provide a thorough understanding of the technology. However, it will be clear that the technology may be practiced without such specific details.

In an embodiment, big data is a broad term for datasets so large or complex that traditional data processing applications are inadequate. Challenges include analysis, capture, data curation, search, sharing, storage, transfer, visualization, querying and information privacy. Big data may refer to the use of predictive analytics or certain other advanced methods to extract value from data in an embodiment. Accuracy in obtaining information from big data may lead to more confident decision making, and better decisions can result in greater operational efficiency, cost reduction and reduced risk.

Querying big data may be cost prohibitive. A linear scan of a dataset of petabyte (PB) size (10¹⁵ bytes) may take days using a solid state drive with a read speed of 6 gigabytes (GB)GB/s, and may take years when a dataset is of exabyte (EB) size (10¹⁸ bytes).

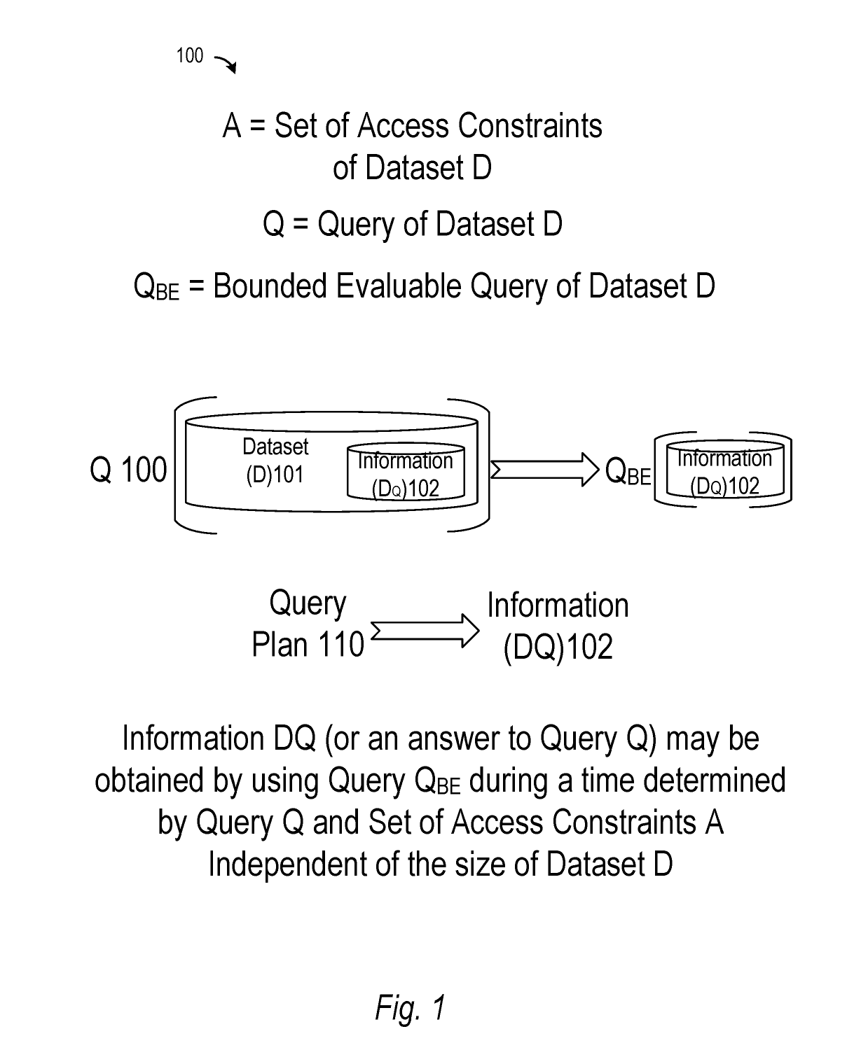

FIG. 1 is a diagram illustrating retrieving information (D_{Q}) 102 of big data stored in memory by determining whether a query (Q) 100 to a dataset (D) 101 is a boundedly evaluable query Q_{BE} according to an embodiment of the present technology. A set A of access constraints of dataset D, including a combination of indices and cardinality constraints, may be used to determine whether query 100 is a boundedly evaluable query Q_{BE}. When a query 100 is a boundedly evaluble query Q_{BE}, a query plan 110 having one or more rewritten queries may be formed to access a bounded amount of information 102 at a far lower cost or amount of time as compared to using query 100. In an embodiment, bounded evaluable refers to a type of query (source query) that may be rewritten into one or more other queries to obtain the same information requested by the source query.

When Q 100 is a boundedly evaluable query Q_{BE}, then a query plan 110 can be executed to retrieve (identify and fetch) bounded information 102 by using the indices in A, in an amount of time determined by Q 100 and using a set A of access constraints. The amount of time is not determined by a size of the dataset 101, no matter how the big dataset 101 grows.

In embodiments, a large number of queries may be boundedly evaluable under a small number of simple access constraints. Accordingly, queries to a dataset of big data may be efficiently answered using query plans and access constraints. In a dataset D₀ of all traffic accidents in the United Kingdom from 1979 to 2005, for example, 77% of conjunctive queries (CQ, a.k.a. SPC) may be boundedly evaluable under a set of 84 simple access constraints. Answers (or information) from boundedly evaluable queries of the dataset D₀ when using an open-source relational database management system (RDBMS) such as MySQL may take on average 14 hours. In contrast, respective query plans for the boundedly evaluable queries may take 9 seconds on average using MySQL in an embodiment.

For a first example, consider a query Q₀ to find the ages of drivers who were involved in an accident in Queen's Park district on May 1, 2005. The query is defined on three (simplified) relations Accident (aid, district, date), Casualty (cid, aid, class, vid) and Vehicle (vid, driver, age), with the three relations recording information including accidents (where and when), casualties (class and vehicle), and vehicles (including driver information such as age), respectively. Query Q₀ is a conjunctive query written as:

Q₀ (xₐ)= [symbol] aid, cid, class, vid, dri
(Accident (aid, “Queen's Park”, “1/5/2005”)̂Casualty (cid, aid, class, vid)̂Vehicle (vid, dri, xₐ)).

It may be costly to compute Q₀ (D₀) directly. The Accident, Casualty and Vehicle relations have more than 7.5, 10, and 13.5 million tuples, respectively. Nonetheless, a closer examination of dataset D₀ reveals the following cardinality constraints:

Ψ₁: Accident (date→aid, 610)

Ψ₂: Casualty (aid→vid, 192)

Ψ₃: Accident (aid→(district, date), 1)

Ψ₄: Vehicle (vid→(driver, age), 1)

The first two cardinality constraints Ψ₁ and Ψ₂ state that from 1979 to 2005, at most 610 accidents happened within a single day, and each accident involved at most 192 vehicles, respectively. Cardinality constraint Ψ₃ indicates that aid is a key for Accident. Similarly, cardinality constraint Ψ₄ indicates that vid is key for Vehicle. These constraints are discovered by simple aggregate queries on dataset D₀. Indices can be built on dataset D₀ based on cardinality constraint Ψ₁ such that for a particular date, it returns all the ids of those accidents (at most 610) that happened on the particular day; similarly for cardinality constraints Ψ₂-Ψ₄. A combination of cardinality constraints and their indices are thus considered access constraints in an embodiment.

Given these access constraints, Q₀ (D₀) may be computed by accessing at most 234850 tuples from dataset D₀, instead of millions. In particular, the following query plan is formed: (1) Identify and fetch at most 610 aid's of Accident tuples with date=“1/5/2005” using the index built on cardinality constraint Ψ₁. (2) For each aid, fetch its Accident tuple using the index for cardinality constraint Ψ₃. Select a set T₁ of tuples with district=“Queen's Park”. (3) For each tuple t∈T₁, fetch a set T₂ of at most 192 vid's from Casualty tuples with aid=t[aid], with the index for cardinality constraint Ψ₂. (4) For each s∈T₂, fetch a Vehicle tuple with vid=s[vid], using the index for cardinality constraint Ψ₄. These tuples suffice for computing Q₀ (D₀), 610+610×192×2 in total, with all being fetched using indices. In an embodiment, 610× 2×2=3050 tuples will be accessed, since the accidents involved two vehicles, on average. In an embodiment, no matter how big the dataset D₀ grows, as long as the dataset D₀ satisfies the cardinality constraints Ψ₁-Ψ₄ (possibly with cardinality bounds mildly adjusted in an embodiment), Q₀ (D₀) may be computed by accessing a small number of tuples determined by the query Q₀ and by the bounds in cardinality constraints Ψ₁-Ψ₄ in an embodiment. Accordingly, query Q₀ is boundedly evaluable under access constraints in cardinality constraints Ψ₁-Ψ₄.

Graphs may be similarly queried using query plans based on bounded evaluability evaluation or determination. In embodiments, 60% of graph pattern queries via subgraph isomorphism are boundedly evaluable under simple access constraints in Web graphs having billions of nodes and edges. In an embodiment, a bounded evaluability evaluation method outperforms conventional subgraph isomorphism methods by 4 orders of magnitude, on average.

Personalized searches or queries may be optimized by bounded evaluablity evaluation in an embodiment. For example, a typical query of Graph Search, Facebook may be “find me restaurants in New York that my friends have been to in 2014”, which only needs data relevant to a designated person (i.e., “me”) in an embodiment. A corresponding query Q_{F} that may have 13.1 billion person tuples and over 1 trillion friend tuples may be:

select rid

from friend f, person p, dine d

where f.pid1=p0 and f.pid2=p.pid and

f.pid2=d.pid and p.city=NYC and d.yy=2014

Q_{F}(rid)=∃p, p1, n, c, dd, mm, yy (friend(p, p1) [symbol] person(p, n, c) [symbol] dine(p, rid, dd, mm, yy) [symbol] p=p0 [symbol] c=NYC [symbol] yy=2014)

The corresponding access constraints (cardinality constraints and indices) are:
Facebook: 5000 friends per person
Each year has at most 366 days
Each person dines at most once per day
pid is a key for relation person
A corresponding query plan:
Fetch 5000 pid's for friends of P0--5000 friends per person
For each pid, check whether he/she lives in NYC--5000 person tuples
For each pid living in NYC, find restaurants where they dined in 2013--5000*366 tuples at most
   The query plan accesses 5000+5000+5000*366 tuples in total as compared to 13.1 billion person tuples, and over 1 trillion friend tuples.

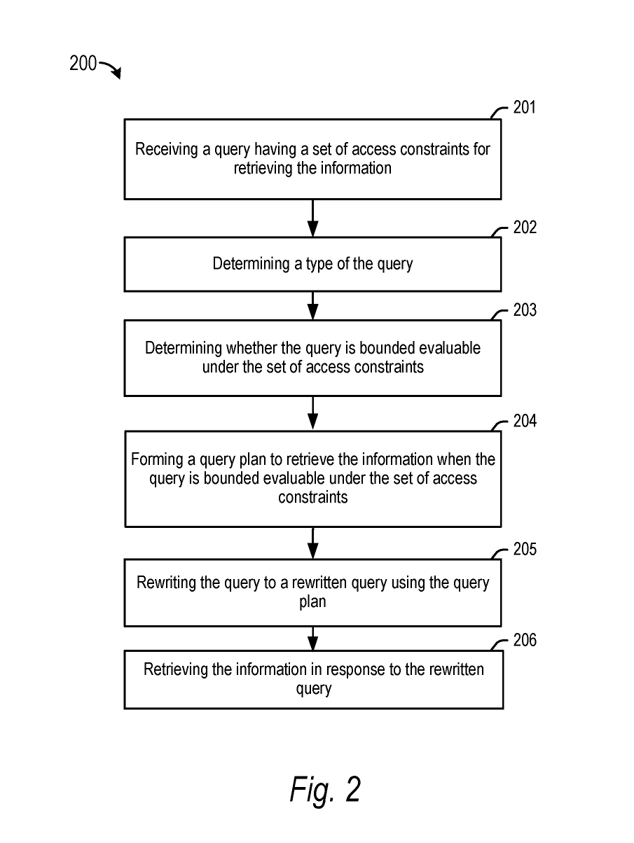

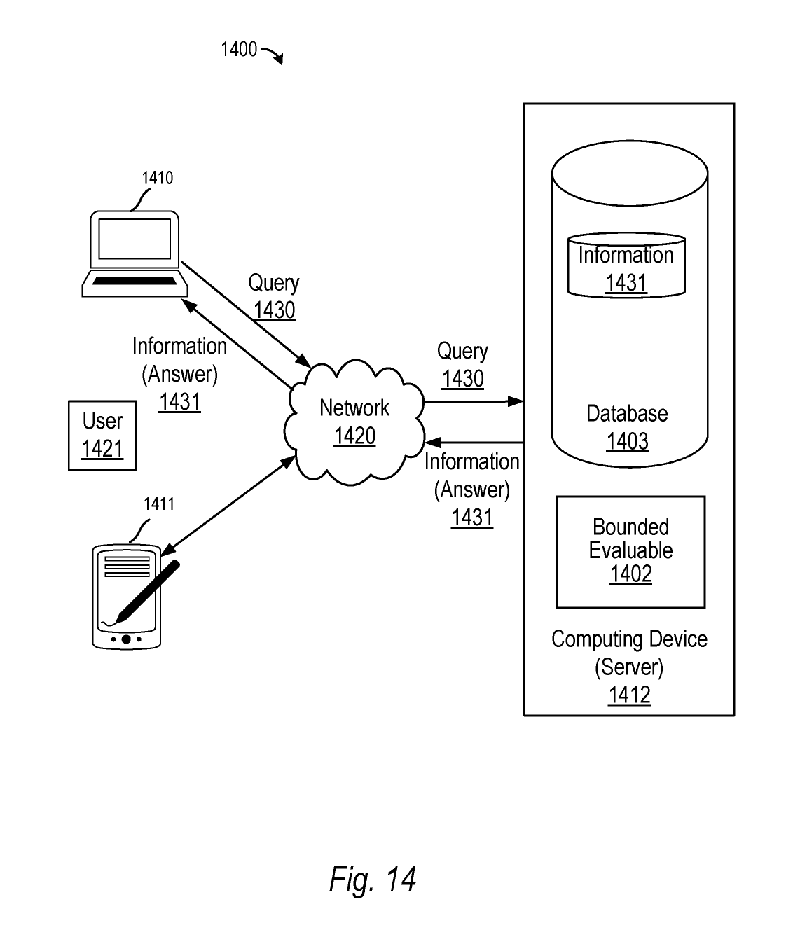

FIGS. 2-4 are flowcharts that illustrate methods for querying big data to obtain a bounded amount of information according to embodiments of the present technology. In embodiments, flowcharts in FIGS. 2-4 are computer-implemented methods performed, at least partly, by hardware and software components illustrated in FIGS. 14-16 and as described below.

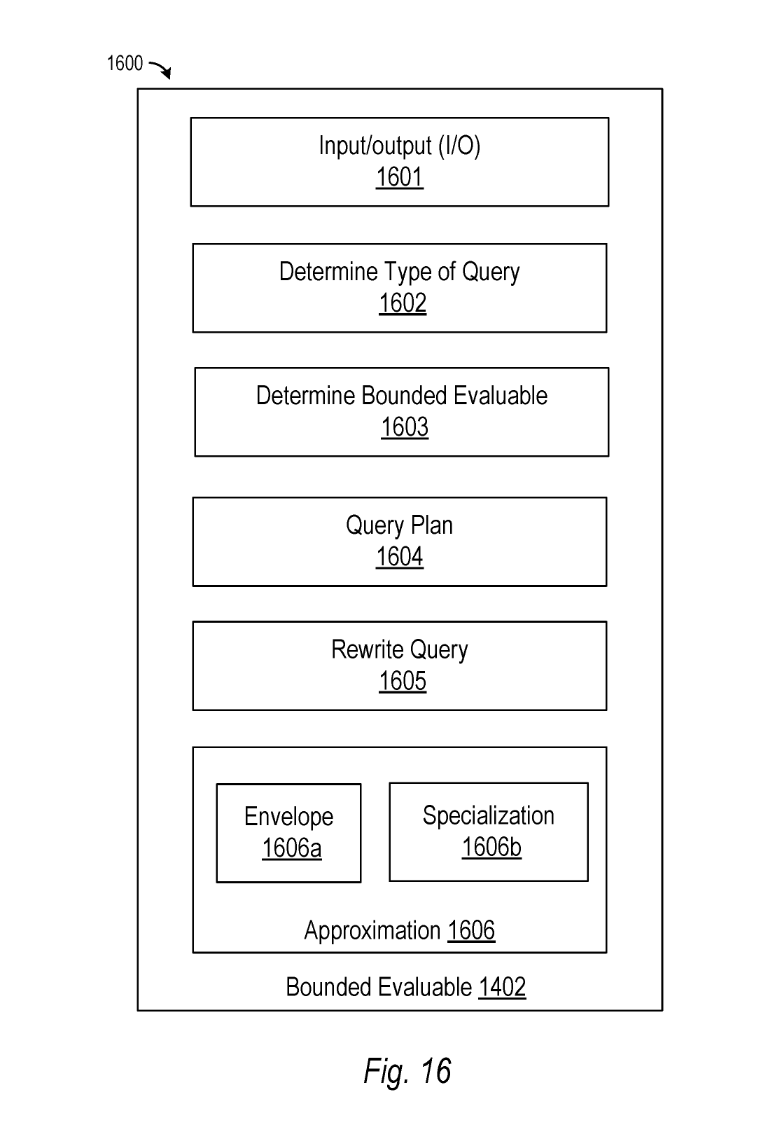

FIG. 2 illustrates a method 200 where logic block 201 shows receiving a query having a set of access constraints to retrieve the information. In an embodiment, the I/O routine 1601 in FIG. 16 performs at least a portion of this function.

Logic block 202 illustrates determining a query type. In an embodiment, the determine type of query routine 1602 in FIG. 16 performs at least a portion of this function.

Logic block 203 illustrates determining whether the query is bounded evaluable under the set of access constraints. In an embodiment, the determine bounded evaluable routine 1603 in FIG. 16 performs at least a portion of this function.

Logic block 204 illustrates forming a query plan to retrieve the information when the query is bounded evaluable under the set of access constraints. In an embodiment, the query plan routine 1604 in FIG. 16 performs at least a portion of this function.

Logic block 205 illustrates rewriting the query to a rewritten query using the query plan. In an embodiment, rewrite query routine 1605 in FIG. 16 performs at least a portion of this function.

Logic block 206 illustrates retrieving the information in response to the rewritten query. In an embodiment, the I/O routine 1601 in FIG. 16 performs at least a portion of this function.

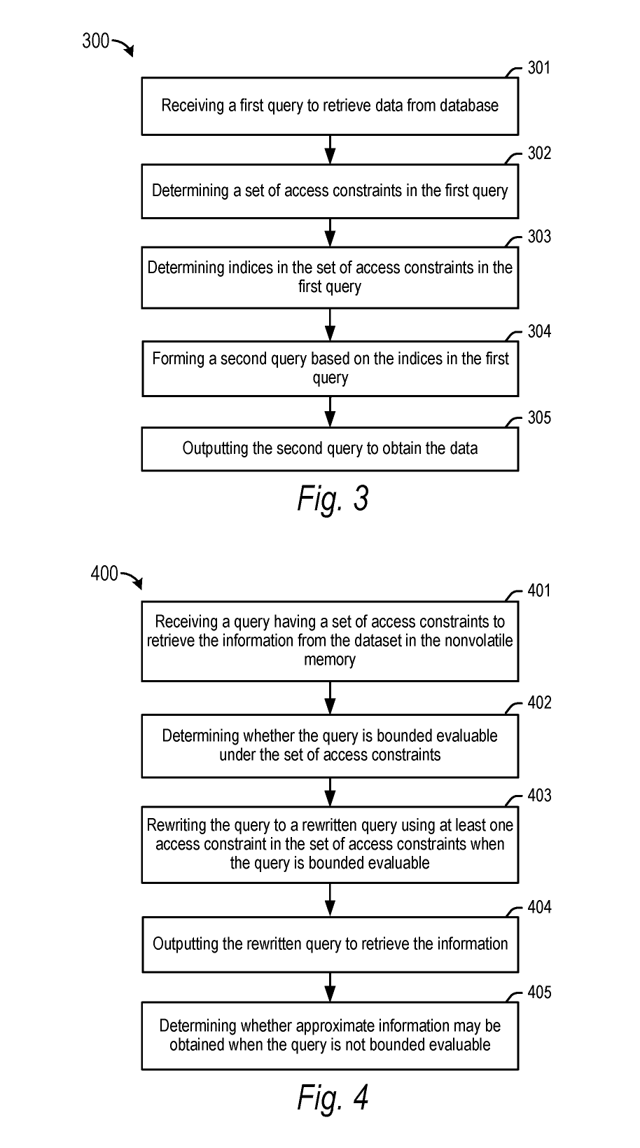

FIG. 3 illustrates a method 300 where logic block 301 illustrates receiving a first query to retrieve data from database. In an embodiment, the I/O routine 1601 in FIG. 16 performs at least a portion of this function.

Logic block 302 illustrates determining a set of access constraints in the first query. In an embodiment, the determine bounded evaluable routine 1603 in FIG. 16 performs at least a portion of this function.

Logic block 303 illustrates determining indices in the set of access constraints in the first query. In an embodiment, the determine bounded evaluable routine 1603 in FIG. 16 performs at least a portion of this function.

Logic block 304 illustrates forming a second query based on the indices in the first query. In an embodiment, the query plan routine 1604 in FIG. 16 performs at least a portion of this function. In an alternate embodiment, rewrite query routine 1605 in FIG. 16 performs at least a portion of this function.

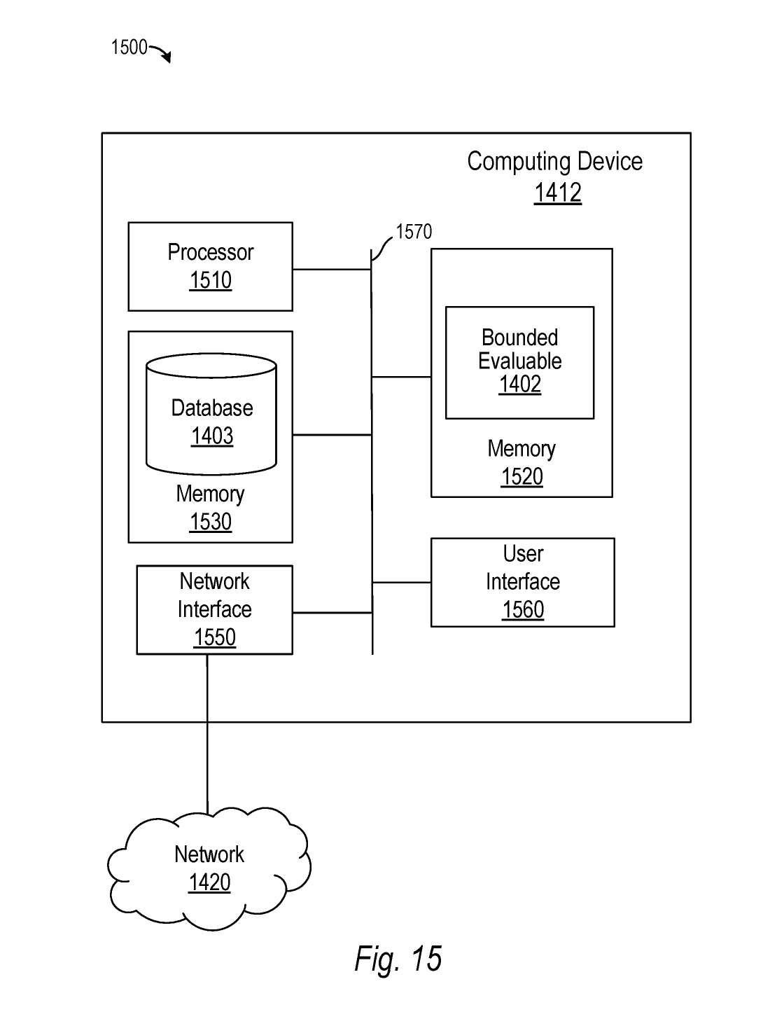

Logic block 305 illustrates outputting the second query to obtain the data. In an embodiment, the I/O routine 1601, as shown in FIG. 16, executed by one or more processors, such as processor 1510 shown in FIG. 15, performs at least a portion of this function.

FIG. 4 illustrates a method 400 where logic block 401 illustrates receiving a query having a set of access constraints to retrieve the information from the dataset in the nonvolatile memory. In an embodiment, the I/O routine 1601 in FIG. 16 performs at least a portion of this function.

Logic block 402 illustrates determining whether the query is bounded evaluable under the set of access constraints. In an embodiment, the determine bounded evaluable routine 1603 in FIG. 16 performs at least a portion of this function.

Logic block 403 illustrates rewriting the query to a rewritten query using at least one access constraint in the set of access constraints when the query is bounded evaluable. In an embodiment, the determine bounded evaluable routine 1603 in FIG. 16 performs at least a portion of this function.

Logic block 404 illustrates outputting the rewritten query to retrieve the information. In an embodiment, the I/O routine 1601 in FIG. 16 performs at least a portion of this function.

Logic block 405 illustrates determining whether approximate information may be obtained when the query is not bounded evaluable. In an embodiment, the approximate routine 1606 in FIG. 16 performs at least a portion of this function.

### Bounded Evaluability

A bounded evaluability problem (BEP) is described. Given a query Q and a set A of access constraints, BEP is to decide whether Q is boundedly evaluable under A. In other words, an evaluation of BEP determines whether it is feasible to compute exact answers to Q in big datasets D by accessing a bounded amount of data from D. It is known that BEP is undecidable for FO, but BEP may be determined for several classes types of FO queries, including CQ, UCQ and ∃FO⁺. In embodiments, BEP is decidable for these practical query classes, but is EXPSPACE--complete for CQ and ∃FO⁺.

The complexity of BEP indicates that an effective syntax of boundedly evaluable queries in CQ exists. For a given set A of access constraints over a relational schema R, there exists a class of CQ queries over R that are covered by A, such that (a) it is in PTIME to decide whether a CQ is covered by A; (b) all CQ queries covered by A are boundedly evaluable under A; and (c) every boundedly evaluable CQ Q under A is A-equivalent to a CQ Q′ covered by A. In an embodiment, Q is A-equivalent to Q′ if for all database instances D of R that satisfy A, Q(D)=Q′(D). The effective syntax indicates what makes a query in CQ boundedly evaluable and aids in forming boundedly evaluable queries. Moreover, typical boundedly evaluable CQ queries are often covered and may be syntactically checked in an embodiment. This provides us with a PTIME method to check the bounded evaluability of conjunctive queries, which may be perceived as the most fundamental and the most widely used queries.

Covered queries are extended to UCQ and ∃FO⁺, so that covered queries also provide an effective syntax for their boundedly evaluable queries. A covered query problem (CQP) is described, to decide whether a query is covered by A, and hence, to aid syntactically check whether a query is boundedly evaluable in an embodiment. CQP is in PTIME for CQ, and is Π₂^{p}-complete for UCQ and ∃FO⁺ in embodiments.

Access constraints, query plans and boundedly evaluable queries over a relational schema are described in detail in embodiments.

A relational schema R consists of a collection of relation schemas (R₁, . . . , Rₙ), where each relation schema Rᵢ has a fixed set of attributes. A countably infinite domain U of data values is assumed, on which instances of R are defined. For an instance D of R, |D| denotes its size, measured as the total number of tuples in D.

Query classes or types of queries include the following. Conjunctive queries (CQ), built up from relation atoms Rᵢ(x̅) (for Rᵢ∈R), and equality atoms x=y or x=c (for constant c), by closing them under conjunction [symbol] and existential quantification ∃. Unions of conjunctive queries (UCQ) are of the form Q=Qₗ∪ . . . ∪Qₖ, where for all i∈[1, k], Qᵢ is in CQ, referred to as a CQ sub-query of Q. Positive existential FO queries (∃FO⁺, a.k.a. SPJU of select-project-join-union queries), are built from relation atoms and equality atoms by closing under [symbol] , [symbol] and ∃. For a query Q in ∃FO⁺, a CQ sub-query of Q is a CQ sub-query in the UCQ equivalence of Q. First-order logic queries (FO) are built from atomic formulas by using [symbol] , [symbol] , negation [symbol] , ∃ and ∀. When x̅ is the tuple of free variables of Q, Q(x̅) will be denoted. With a query Q(x̅) with |x̅|=m and a database D, an answer to Q in D, denoted by Q(D), is the set {ā∈adom(D)^{m}|D|=Q(ā)}, where the active domain, adom (D), consists of all constants appearing in D or Q.

An access schema A over a relational schema R is a set of access constraints of the form:

R(X→Y,N),

where R is a relation schema in R, X and Y are sets of attributes of R, and N is a natural number. A relation instance D of R satisfies the constraint when for any X-value ā in D, D_{Y}(X=ā)≦N, where D_{Y}(X=ā)={t[Y]|t∈D, t[X]=ā}; and there exists an index on X for Y that given an X-value ā, retrieves D_{Y}(X=ā).

For example, the cardinality constraints Ψ₁-Ψ₄ described above, together with their indices, are access constraints. An access constraint is a combination of a cardinality constraint and an index on X for Y. This indicates that given any X-value, there exist at most N distinct corresponding Y-values, and these Y values can be efficiently retrieved by using the index.

D satisfies access schema A, denoted by D|=A, when D satisfies all the constraints in A.

Before describing boundedly evaluable queries in detail, query plans are described. A query Q in the relational algebra over schema R may be described in terms of projection operator π, selection σ, Cartesian product x, union ∪, set difference −, and renaming ρ. A query plan for Q is a sequence:

ξ(Q,R): T₁=δ₁, . . . , Tₙ=δₙ,

such that (1) for all instances D of R, Tₙ=Q(D), and (2) for all i∈[1, n], δᵢ is one of the following:

{a}, where a is a constant in Q; or

fetch(X∈Tⱼ,R,Y), where j<i, and Tⱼ has attributes X; for each ā∈Tⱼ, it retrieves D_{XY}(X=ā) from D, and returns ∪_{ā∈T}_{ⱼ}D_{XY}(X=ā); or

π_{Y}(Tⱼ), σ_{C}(Tⱼ) or ρ(Tⱼ), for j<i, a set Y of attributes in Tⱼ, and condition C defined on Tⱼ; or

Tⱼ×Tₖ, Tⱼ∪Tₖ or Tⱼ−Tₖ, for j<i and k<i.

The result ξ(D) of applying ξ(Q,R) to D is Tₙ.

A query plan ξ(Q,R) is boundedly evaluable under an access schema A in an embodiment when (1) for each fetch (X∈Tⱼ,R,Y) in it, there exists a constraint R(X→Y′,N) in A such that Y⊂X∪Y′, and (2) the length n of ξ(Q,R) (i.e., the number of operations) is bounded by an exponential in |R|, |A|, and |Q|, which are the sizes of R, A and Q, respectively, independent of dataset D. A query plan longer than exponential in |R|, |A| and |Q| may not be practical in an embodiment.

In other words, when query plan ξ(Q,R) is boundedly evaluable under A, then for all instances D of R that satisfy A, ξ(Q,R) indicates how to fetch D_{Q}⊂D with the indices in A such that Q(D)=Q(D_{Q}), where D_{Q} is the set of all tuples fetched from D by following ξ(Q,R). In particular, D_{Q} is bounded. |D_{Q} | is determined by Q and constants in A only in an embodiment. Moreover, the time for identifying and fetching D_{Q} also depends on Q and A only in an embodiment (assuming that given an X-value ā, it takes O(N) time to fetch D_{XY}(X=ā) in D with the index in R (X→Y,N)). For example, a boundedly evaluable query plan for Q₀ is provided above under access constraints Ψ₁-Ψ₄.

For a query Q in a language L and an access schema A, both over the same relational schema R, Q is boundedly evaluable under A when it has a boundedly evaluable query plan ξ(Q,R) under A such that in each Tᵢ=δᵢ of ξ(Q,R),

when L is CQ, then δᵢ is a fetch, π, σ, x or ρ operation;

when L is UCQ, δᵢ can be fetch, π, σ, x or ρ, and there is k≦|Q| such that the last k−1 operations of ξ(Q,R) are ∪, and ∪ does not appear anywhere else in ξ(Q,R);

when L is ∃FO⁺, then δᵢ is fetch, π, σ, x, ∪ or ρ; and

when L is FO, δᵢ can be fetch π, σ, x, ∪, \ or ρ.

In other words, when Q is boundedly evaluable under A, then for all instances D of R that satisfy A, there exists D_{Q}⊂D such that: (a) Q(D_{Q})=Q(D), (b) the time for identifying and fetching D_{Q} is determined by Q and A only, and (c) the size |D_{Q} | is also independent of |D|.

Access constraints, in an embodiment, are described as follows:

R(X→Y,s(•)),

where s(•) is a (sublinear) function in |D|. An instance D of R satisfies the constraint when for any given X-value ā, D_{Y}(X=ā) may be retrieved from D by using an index on X for Y, such that |D_{Y}(X=ā)|≦s(|D|).

In other words, |D_{Y}(X=ā)| is bounded by a function in |D|, e.g., log(|D|), rather than by a constant. These access constraints are referred to as access constraints with non-constant cardinality. Constraints R(X→Y,N) are a special form when s(•) is a constant N, and are referred to access constraints with constant cardinality or simply access constraints in an embodiment. Access constraints with non-constant cardinality are easier to be satisfied, and still allow us to query big data by accessing a small fraction D_{Q} of the data, although |D_{Q} | is no longer independent of |D|.

While access constraints R (X→Y,N) with constant cardinality in a sequel are described, characterizations and complexity described below apply to access constraints with non-constant cardinality, as long as function s(•) is PTIME computable. Similarly, the results on QSP described below apply for general access constraints.

### Characterizing Bounding Evaluablity

A bounded evaluability problem, denoted by BEP (L) for a query class L, is stated as follows:

INPUT: A relational schema R, an access schema A over R and a query Q∈L over R.

QUESTION: Is Q boundedly evaluable under A?

While BEP (FO) is undecidable, BEP (FO) is decidable for several practical fragments of FO. However, the complexity bounds of BEP for these query classes are rather high. An effective syntax for boundedly evaluable queries in CQ is described to cope with the complexity. A syntax is provided in terms of a notion of covered queries, which can be checked in PTIME. The notion of covered queries is extended to UCQ and ∃FO⁺, to characterize their boundedly evaluable queries. Complexity for deciding whether their queries are covered is also described.

### Determining Bounding Evaluablity

Determining whether a query, even CQ, is boundedly evaluable, is nontrivial.

For a second example, consider an access schema A₁ and a query Q₁ defined over a relation schema R₁(A,B,E,F):

A₁={φ₁=R₁(A→B,N₁),φ₂=R₁(E→F,N₂)},

Q₁(x,y)=∃x₁,x₂(R(x₁,x,x₂,y) [symbol] x₁=1 [symbol] x₂=1)

Under A₁, Q₁ is seemingly boundedly evaluable. Given an instance D₁ of schema R₁, values x₁=1 and x₂=2, x values may be extracted from D₁ by using φ₁, and y values by φ₂. However, there exists no bounded query plan for Q₁. A₁ does not provide us with indices to check whether these x and y values come from the same tuples in D₁.

For a third example, consider A₂ and Q₂ defined on R₂(A,B):

A₂={φ₃=R₂(A→B,1)},

Q₂(x)=∃x₁,x₂(R₂(x,x₁) [symbol] R₂(x,x₂) [symbol] x₁=1 [symbol] x₂=2).

Query Q₂ is boundedly evaluable under A, although A₂ does not help us retrieve x values from an instance D₂ of R₂. To see why Q₂ is bounded evaluable under A₂, for any x value, it is impossible to find both (x,1) and (x, 2) in D₂ that satisfies A₂, because of φ₃. Therefore, Q₂(D₂)=Ø, i.e., Q₂ is not satisfiable by instances D₂ of R₂ that satisfy A₂. Hence a query plan for empty query suffices to answer Q₂ in D₂.

For a fourth example, consider A₃ and Q₃ defined on R₃ (A, B, C):

A₃={φ₄=R₃(Ø→C,1),φ₅=R₃(AB→C,N)},

Q₃(x,y)=∃x₁,x₂,z₁,z₂,z₃(R₃(x₁,x₂,x) [symbol] R₃(z₁,z₂,y) [symbol] R₃(x,y,z₃) [symbol] x₁=1 [symbol] x₂=1).

At first glance, Q₃ is not boundedly evaluable under A₃, since A₃ does not help us check R(z₁, z₂, y). However, Q₃ is “A₃-equivalent” to Q's, i.e., for any instance D₃ of R₃, when D₃|=A₃, then Q′₃ (D₃) Q′₃ (D₃), where

Q′₃(x,x)=R₃(1,1,x) [symbol] R₃(x,x,x).

Query Q's is boundedly evaluable under A₃. Hence, Q₃ is boundedly evaluable under A₃ since a boundedly evaluable query plan for Q's is also a query plan for Q₃.

To see that Q₃ is “A₃-equivalent” to Q's, observe the following: (a) by φ₄, x, y and z₃ must take the same (unique) value c₀ from D₃, which can be fetched by using the index built for φ₄; hence R(x,y,z₃) becomes R(x, x, x), and (b) ∃z₁,z₂(R(1,1,x) [symbol] R(z₁,z₂,y)) is equivalent to R(1,1,x), thus R(z₁,z₂,y) can be removed. Moreover, Q′₃ is boundedly evaluable under A₃ since by φ₅, it may be checked whether (1,1, x) and (x, x, x) are in D₃ when x=c₀, using the index for φ₅.

As illustrated by this example, to decide whether a CQ Q is boundedly evaluable under an access schema A, a determination is made (a) whether Q is “A-equivalent” to a query Q′ that is boundedly evaluable under A, or (b) whether the indices in A “cover” attributes corresponding to variables in Q.

In other words, consider an access schema A and a query Q, both defined over the same relational schema R. Q is A-satisfiable when there exists an instance D of R such that D|=A and Q(D)≠Ø.

When Q is a query in CQ, it is in PTIME to decide whether there exists D such that Q(D)≠Ø. In contrast, A-satisfiability is intractable for CQ.

BEP for UCQ and ∃FO⁺ is decidable as described below. In particular, bounded evaluability analysis or determination when a union is present is described. For two UCQ Q=∪_{i∈[1,m]}Qᵢ and Q′=∪_{j∈[1,n]}Q′ⱼ, Q⊂Q′ when and only when for each Qᵢ, there exists Qⱼ, such that Qᵢ⊂Q′. However, this no longer holds when A-containment [symbol] _{A} under an access schema A is considered.

For a fifth example, consider a relation schema R(X), an access schema A with R(Ø→X,2), and queries below:

Q(x)=∃y(Q_{c}( ) [symbol] Q_{ψ}((x,y)),

Q_{c}( )=∃y₁,y₂(R(y₁) [symbol] y₁=1 [symbol] R(y₂) [symbol] y₂=0),

Q′(x)=Q₁(x)∪Q₂(x),

Q₁(x)=∃y(Q_{ψ}(x,y) [symbol] y=1),

Q₂(x)=∃y(Q_{ψ}(x,y) [symbol] y=0),

where Q_{ψ} is a CQ, and Q_{c} and A ensure that an R relation encodes Boolean domain {0,1}. Q [symbol] _{A} Q′ may be verified. However, Q [symbol] _{A}Q₁ and Q [symbol] _{A} Q₂.

As a seventh example, consider R′(A,B,C), A′ consisting of R′(A→B,N) only, and a query Q=Q₁∪Q₂, where

Q₁(y)=∃x,z(R′(x,y,z) [symbol] x=1),

Q₂(y)=∃x,z(R′(x,y,z) [symbol] x=1 [symbol] z=y).

Then under A′, Q₁ and Q are boundedly evaluable, but Q₂ is not. Hence a CQ sub-query of a boundedly evaluable UCQ Q may not be boundedly evaluable itself, as long as it is contained in other sub-queries of Q.

Accordingly, UCQ is bounded evaluable under an access schema A, when and only when Q is A-equivalent to a UCQ Q′=Q₁∪ . . . ∪Qₖ such that for each i∈[1,k], CQ sub-query Qᵢ is boundedly evaluable under A.

A query Q in ∃FO⁺ is also boundedly evaluable, since a query in ∃FO⁺ is equivalent to a query in UCQ. BEP is thus decidable for UCQ and ∃FO⁺.

### Effective Syntax

While BEP is decidable for CQ and ∃FO⁺, its complexity is too high to make practical use of bounded evaluability analysis in an embodiment. Thus, an effective syntax is described for their boundedly evaluable queries, with lower complexity.

To decide whether a CQ Q is boundedly evaluable under an access schema A, a determination is made (a) whether Q is “A-equivalent” to a CQ Q′ that is boundedly evaluable under A, or (b) whether the indices for constraints in A “cover” attributes corresponding to variables in Q. Queries Q in CQ are “covered by” A as described below, i.e., when the cardinality constraints and indices in A provide us with sufficient information to fetch tuples for answering Q.

Variables in Q that have to be “covered by” A are described. A set of all variables that occur in Q, denoted by var(Q), are either free or bound. Assume without loss of generality that Q is safe, i.e., each variable in var(Q) is equal to either a variable occurring in a relation atom or a constant in Q. Queries Q also are satisfiable, i.e., each variable can be equal to at most one constant. Moreover, only variables appear in relation atoms of Q is assumed without loss of generality, while constants are in equality atoms in an embodiment.

For a variable x∈ var(Q), denoted by eq(x,Q) a set of all variables in Q that are equal to x as determined by equality atoms of the form y=z in Q, and the transitivity of equality. In an embodiment, eq⁺(x,Q) is defined as the extension of eq(x,Q) by including variables y such that x=y can be inferred also from conditions z=c for some constant C (e.g., x=c and y=c). In an embodiment, x is referred to as a constant variable when eq(x,Q) contains a variable y such that y=c occurs in Q.

A variable x is called data-dependent when eq(x,Q) contains variables that occur in relation atoms of Q, and it is called data-independent otherwise. A CQ Q(x̅) can be equivalently written as Q_{dd} (x̅₁) [symbol] Q_{di} (x̅₂) such that x̅=(x̅₁, x̅₂), x̅₁, and x̅₂ are disjoint, and Q_{dd} and Q_{di}, consist solely of data-dependent and independent variables, respectively.

As a eighth example, consider the query:

Q(x,y,u,v)=R(x,y) [symbol] x=1 [symbol] x=y [symbol] u=1 [symbol] u=v.

Then eq(x,Q)={x, y} and eq⁺(x,Q)={x, y, u, v}. Note that x and y are data-dependent, but u is not, although u∈ eq⁺(x,Q). It is to define data-independent variables that eq(x,Q) is separated from eq⁺(x,Q).

A set cov(Q,A) of variables covered by A is defined in an embodiment. In other words, cov(Q,A) contains all variables in Q whose values are determined by Q or by A. In an embodiment:

cov(Q,A)=cov(Q_{dd},A)∪cov(Q_{di},A)

where cov(Q_{di},A)=var(Q_{di}), since the values of such variables do not need to be retrieved from a database D, or to be verified with data in D. In an embodiment, cov(Q_{dd}, A) is defined inductively, starting from cov₀(Q_{dd},A)=Ø. When i>0, an access constraint φ=R(X→Y,N) is applicable to an atom R(x̅, y̅, z̅) in Q_{dd} when the following conditions are satisfied:

variables x̅ correspond to X, and either are already in covᵢ₋₁(Q,A) or are constant variables; and

y̅ corresponds to Y, and there exists a variable y in y̅ such that y is not yet in covᵢ₋₁(Q,A).

In an embodiment, covᵢ(Q_{dd},A) is defined by extending covᵢ₋₁(Q_{dd}, A) with the following after each application of a constraint:

variables in eq⁺(x,Q_{dd}) for all constant variables x in x̅ that are not already in covᵢ₋₁(Q, A); and

variables in eq⁺(y,Q_{dd}) for each y∈y̅.

By using eq⁺ instead of eq, whenever variable x is covered and x=c holds, then all other variables that are equal to constant C are covered as well. In an embodiment, cov(Q_{dd},A)=covₖ(Q_{dd},A) when covₖ(Q_{dd},A)=covₖ₊₁(Q,A), i.e., as “the fixpoint”.

As described below, cov(Q,A) is well defined, regardless of the order in which constraints in A are applied. For any CQ Q and access schema A over a relational schema R, cov(Q,A) is uniquely determined and can be computed in PTIME in |Q|, |R|, and |A|.

In an embodiment, covered queries are defined as follows:

A CQ Q(x̅) is covered by A when:

its free variables are covered, i.e., x̅⊂cov(Q,A);

for all non-covered variables y∉ cov(Q,A), y is non-constant and only occurs once in Q; and

each relation atom R(w̅) in Q is indexed by A, i.e., there is a constraint R (Y₁→Y₂, N) in A such that (a) all variables in w̅ corresponding to attributes Y₁ must be covered, and (b) let y̅ be w̅ excluding bound variables that only occur once in Q; then each y in y̅ corresponds to an attribute in Y₁∪Y₂.

In other words, condition (a) ensures that the values of all free variables of Q are either constants in Q or can be retrieved from a database instance with indices in A. Conditions (b) and (a) together assert that non-covered variables are existentially quantified and do not participate in “joins.” Hence, for any instance D of R, Q(D) does not depend on what values these variables take. Condition (c) requires that when t[Y] values of an R tuple t to answer Q is needed, the values of all attributes in Y come from the same tuple t and can be retrieved (checked) by using an index in A.

For example, Query Q₃ of the fourth example above is covered by A₃: (a) cov(Q₃,A₃)={x, y, z₃, x₁, x₂}, including all free variables x and y; (b) while z₁ and z₂ are uncovered, they satisfy condition (b), and thus their values has no impact on answers to Q₃; and (c) relations R (x₁, x₂, x) and R (x, y, z₃) are indexed by φ₅, and R (z₁, z₂, y) is indexed by φ₄.

In contrast, query Q₁ of the second example is not covered by A₁. Q₁ does not satisfy condition (c), since relation atom R (x₁, x, x₂, y) is not indexed by any constraint in A₁.

As another example, query Q₀ in the first example is covered by A₀ consisting of Ψ₁-Ψ₄. Indeed, its free variable xₐ is covered, non-covered variables cid and class occur only once in Q₀, and all its relation atoms are indexed; Accident by Ψ₃, Casualty by Ψ₂ and Vehicle by Ψ₄.

Covered CQ queries provide us with an effective syntax for boundedly evaluable CQ queries. In embodiments, most boundedly evaluable CQ queries are covered.

For an access schema A and a CQ Q, Q is boundedly evaluable under A when and only when:

Q is A-equivalent to a CQ Q′ that is covered by A;

when Q is covered by A, then Q is boundedly evaluable under A; and

checking whether Q is covered by A is in PTIME in |Q|, |A| and |R|, where R is the relational schema over which Q and A are defined.

Further, consider query plans, an access schema A and queries over a relational schema R.

Every boundedly evaluable query plan ξ under A for a CQ determines a CQ Q_{ξ} such that Q_{ξ} is covered by A and for all instances D of R. When D|=A, then when ξ is applied to D, ξ(D)=Q_{ξ}(D). This is verified by induction on the length of ξ, constructing Q_{ξ} step by step.

When a CQ Q is covered by A, then Q is boundedly evaluable under A. This is verified by generating a boundedly evaluable query plan ξ for Q, mimicking each step of the evaluation of Q with an operation in ξ.

Coverage characterizes what makes a CQ boundedly evaluable, and is described below. For instance, Q₀ of the first example is covered by A₀, and Q₃ of the fourth example is covered by A₃. As described previously, both queries are boundedly evaluable. The characterization is, however, not purely syntactic. Some boundedly evaluable CQ queries may not be covered, but are A-equivalent to a covered query in CQ. For example, Q₂ of the third example is not covered by A₂; its free variable x is not in cov(Q₂, A₂). Nonetheless, Q₂ is A₂—equivalent to a query Q₂, (x)=(x=1 [symbol] x=2), which is covered by A₂ since its variable is data-independent.

Covered queries for ∃FO⁺ (and hence UCQ) are described. A query Q in ∃FO⁺ is covered by an access schema A when for each Qᵢ of its CQ sub-queries, either (a) Qᵢ is covered, or (b) for all A—instances θ(T_{Q}) of Qᵢ, there is j∈[1, k] such that θ(u)∈Qⱼ(θ(T_{Q})) and Qⱼ is covered by A

Covered queries are also an effective syntax for boundedly evaluable queries in ∃FO⁺.

An ∃FO⁺ query is boundedly evaluable under an access schema A when and only when it is A-equivalent to an ∃FO⁺ query that is covered by A and each ∃FO⁺ query covered by A is boundedly evaluable under A.

The query coverage problem, denoted by CQP(L), is stated as follows.

INPUT: R, A and Q as in BEP.

QUESTION: Is Q covered by A?

A determination of CQP aids in syntactically checking whether Q is boundedly evaluable under an access schema.

CQP is in PTIME for CQ, as opposed to EXPSPACE-complete for BEP. It provides a tractable syntactic method to check the bounded evaluability of CQ. However, CQP is nontrivial when it comes to UCQ and ∃FO⁺, although it is easier than its BEP counterparts.

CQP is in PTIME for CQ; and

Π₂^{p}-complete for UCQ and ∃FO⁺.

Alternatively, a query Q may be defined in ∃FO⁺ to be covered when each of its CQ sub-query is covered. When so, CQP(UCQ) is in PTIME and CQP (∃FO⁺) is coNP-complete, down from Π₂^{p}-complete. In an embodiment, a more general notion of covered queries for ∃FO⁺, to include most boundedly evaluable UCQ and ∃FO⁺ queries, is used.

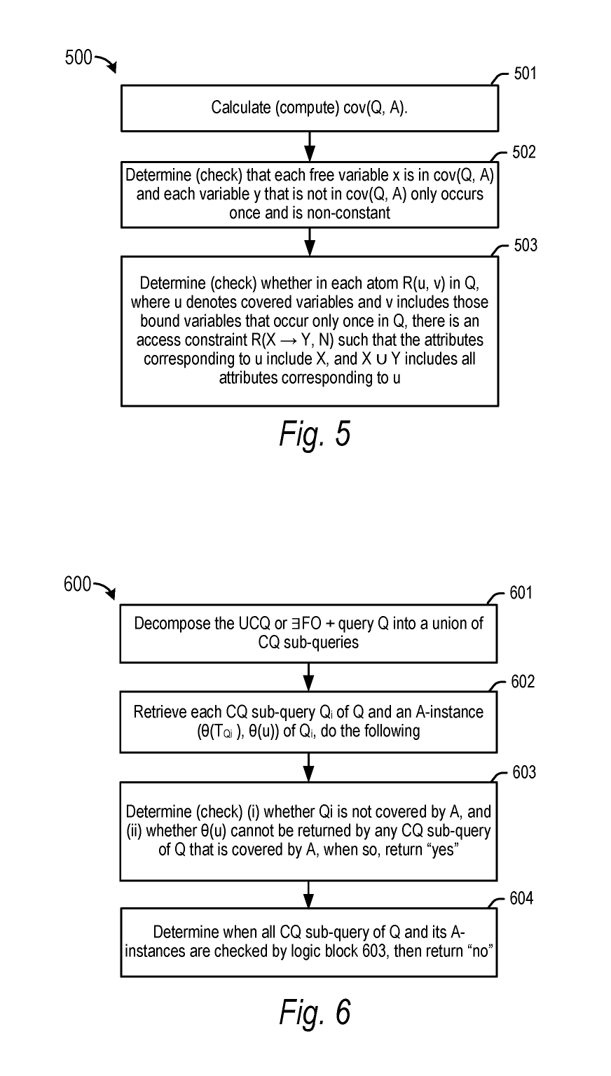

FIG. 5 is a flowchart that illustrates a method 500 to determine whether a query is bounded evaluable (covered) under a set of access constraints for CQ using coverage checking according to embodiments of the present technology. For a CQ Q(x) and an access schema A, both defined over R, method 500 determines whether Q(x) is covered by A. In an embodiment, method 500 is a PTIME method.

Logic block 501 illustrates calculating cov (Q, A). In an embodiment, the determine bounded evaluable routine 1603 in FIG. 16 performs at least a portion of this function.

Logic block 502 illustrates determining that each free variable x is in cov (Q, A) and each variable y that is not in cov (Q, A) only occurs once and is non-constant. In an embodiment, the determine bounded evaluable routine 1603 in FIG. 16 performs at least a portion of this function.

Logic block 503 illustrates determining whether in each atom R(u, v) in Q, where u denotes covered variables and v includes those bound variables that occur only once in Q, there is an access constraint R(X→Y, N) such that the attributes corresponding to u include X, and X∪Y includes all attributes corresponding to u. In an embodiment, the determine bounded evaluable routine 1603 in FIG. 16 performs at least a portion of this function.

FIG. 6 is a flowchart that illustrates a method 600 to determine whether a query is bounded evaluable (covered) under a set of access constraints for UCQ and ∃FO⁺ using coverage checking according to embodiments of the present technology.

Logic block 601 illustrates decomposing the UCQ or ∃FO⁺ query Q into a union of CQ sub-queries. In an embodiment, the determine bounded evaluable routine 1603 in FIG. 16 performs at least a portion of this function.

Logic block 602 illustrates retrieving each CQ sub-query Qᵢ of Q and an A-instance (θ(T_{Qi}), θ(u)) of Qᵢ. In an embodiment, the determine bounded evaluable routine 1603 in FIG. 16 performs at least a portion of this function.

Logic block 603 illustrates determining whether Qᵢ is not covered by A, and whether θ (u) cannot be returned by any CQ sub-query of Q that is covered by A; when so, return “yes”. In an embodiment, the determine bounded evaluable routine 1603 in FIG. 16 performs at least a portion of this function.

Logic block 604 illustrates determining when all CQ sub-query of Q and its A-instances are checked by logic block 603, then return “no”. In an embodiment, the determine bounded evaluable routine 1603 in FIG. 16 performs at least a portion of this function.

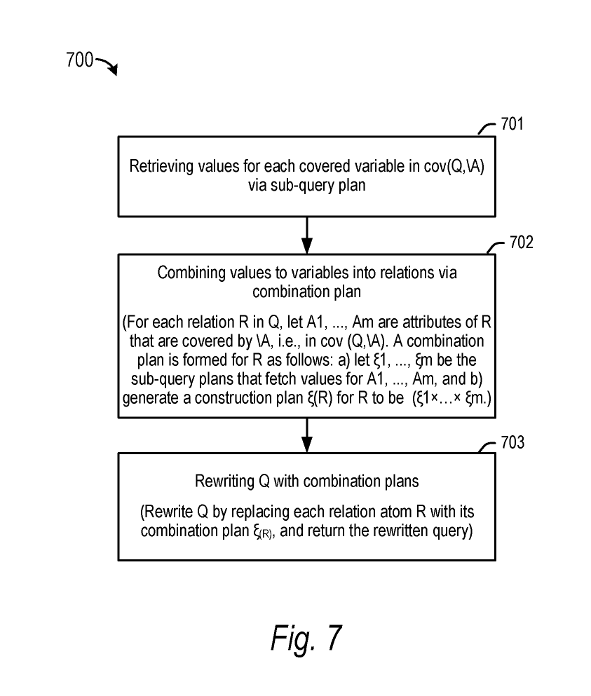

FIG. 7 is a flowchart that illustrates a method 700 to generate a bounded evaluable query plan for covered queries according to embodiments of the present technology.

Logic block 701 illustrates retrieving values for each covered variable in cov(Q,\A) via sub-query plan. In an embodiment, the query plan routine 1604, as shown in FIG. 16, executed by one or more processors, such as processor 1510 shown in FIG. 15, performs at least a portion of this function in an embodiment. In an alternate embodiment, rewrite query routine 1605 in FIG. 16 performs at least a portion of this function.

Logic block 702 illustrates combining values to variables into relations via combination plan. In an embodiment, for each relation R in Q, let A1 . . . Am be attributes of R that are covered by \A, i.e., in cov (Q,\A). A combination plan is formed for R as follows: a) let ξ₁, . . . , ξₘ be the sub-query plans that fetch values for A1, . . . , Am, and b) generate a construction plan ξ(R) for R to be (ξ₁x . . . xξₘ). In an embodiment, the query plan routine 1604 in FIG. 16 performs at least a portion of this function in an embodiment. In an alternate embodiment, rewrite query routine 1605 in FIG. 16 performs at least a portion of this function.

Logic block 703 illustrates rewriting query Q with combination plans. In an embodiment, rewrite query Q by replacing each relation atom R with its combination plan ξ_{(R)}, and return the rewritten query. In an embodiment, the query plan routine 1604 in FIG. 16 performs at least a portion of this function in an embodiment. In an alternate embodiment, rewrite query routine 1605 in FIG. 16 performs at least a portion of this function.

### Approximations

When a query Q is boundedly evaluable under an access schema A, in all datasets D that satisfy schema A, Q(D) may be computed by accessing a bounded amount of data in an embodiment. When query Q is not boundedly evaluable, however, it may be cost-prohibitive to compute exact answers to query Q in datasets D. How to compute approximate query answers to query Q when query Q is not boundedly evaluable is described below. In particular, upper and lower envelopes and query specialization are described.

For example, consider an access schema A and a query Q, both defined over a relational schema R, where Q is in query language L, and Q is not boundedly evaluable under A.

Queries Qₗ and Qᵤ may be found in L such that:

Qₗ and Qᵤ are boundedly evaluable under A; and

for all instances D of R that satisfy A, Qₗ(D)⊂Q(D)⊂Qᵤ(D), and |Q(D)−Qₗ(D)|≦Nₗ, |Qᵤ(D)−Q(D)|≦Nᵤ, where Nₗ and Nᵤ are constants derived from Q and constants in A. Qᵤ and Qₗ are referred to as upper and lower envelopes of Q under A, respectively, and call Nᵤ (resp. Nₗ) an approximation bound of Qᵤ (resp. Qₗ) with respect to Q.

In other words, upper and lower envelopes approximate query Q. For any instance D of R, as long as D|=A, Qᵤ(D) and Qₗ(D) may be efficiently computed by accessing a bounded amount of data. In an embodiment, Qᵤ(D) and Qₗ(D) are not too far from the exact answers Q(D): Qᵤ(D) includes all tuples in Q(D), and it has at most Nᵤ tuples that are not in Q(D). Moreover, all tuples in Qₗ(D) are also in Q(D), and at most Nₗ tuples in Q(D) are not in Qₗ(D) in an embodiment.

In a ninth example, consider a relation schema R(A,B), an access schema A consisting of a single constraint R(A→B,N) for a constant N, and two queries in CQ:

Q₁(x)=∃y,z,w(R(w,x) [symbol] R(y,w) [symbol] R(x,z) [symbol] w=1);

Q₂(x,y)=∃w(R(w,x) [symbol] R(y,w) [symbol] w=1).

In the ninth example, Q₁ is not boundedly evaluable under A. However, it has upper envelope Qᵤ and lower envelope Qₗ;

Qᵤ(x)=∃y,z(R(1,x) [symbol] R(x,z)),

Qₗ(x)=∃y,z(R(1,x) [symbol] R(y,1) [symbol] R(x,y) [symbol] R(x,z)).

In contrast, Q₂ is not boundedly evaluable under A and it has neither upper nor lower envelope. As shown in the ninth example, a query may not have upper or lower envelopes, e.g., Q₂. Determining whether a query Q has envelopes (upper and lower) under an access schema is described below in order to determine whether it is possible to approximate Q with boundedly evaluable queries that warrant constant approximation bounds.

### Determining Upper Envelopes

Upper envelopes of a particular syntactic form are defined in an embodiment.

Assume a relational schema R over which queries and access schemas are defined. A relaxation of a CQ Q(x̅)=∃y̅ψ(x,y) is a CQ Q′(x̅)=∃y̅′ψ′(x̅,y̅′) such that y̅′ ⊂y̅, and moreover, every atomic formula in ψ′ is an atomic formula in ψ.

For example, query Qᵤ given in ninth example is a relaxation of Qₗ. In other words, Q′ is obtained by removing tuples from the tableau representing Q. Note that Q and Q′ have the same set of free variables and Q⊂Q′. Hence Q [symbol] _{A}Q′ for any access schema A defined over R.

A relaxation to ∃FO⁺ is also described. A relaxation of an ∃FO⁺ query Q is a query Q′ in ∃FO⁺ such that each CQ sub-query Qᵢ′ of Q′ is a relaxation of a CQ sub-query of Q.

An upper envelope problem for a query class L, denoted by UEP(L), is described as follows.

INPUT: A relational schema R, an access schema A over R, and a query Q∈L over R that is not boundedly evaluable under A.

QUESTION: Does there exist an upper envelope Qᵤ of Q under A? In particular, when L is CQ, UCQ or ∃FO⁺, determine whether there exists Qᵤ that is a relaxation of Q and is covered by A.

In an embodiment, searching for upper envelopes that can be syntactically checked may reduce the cost of checking their bounded evaluability.

In order to determine what queries can have an upper envelope, a condition that is necessary for the existence of both upper and lower envelopes is described below.

A query Q is bounded under A when there exists a constant C determined by Q and A such that for all instances D of R, when D|=A, then there exists D_{Q}⊂D, where:

Q(D_{Q})=Q(D); and

|D_{Q} |≦c, i.e., |D_{Q} | is independent of |D|.

Hence, there exists a constant cᵣ such that |Q(D)|≦cᵣ.

In an embodiment, a notion of boundedness is weaker than the notion of boundedly evaluability. A boundedly evaluable query is also bounded, but a bounded query may not be boundedly evaluable, i.e., it does not necessarily have an boundedly evaluable query plan. For example, query Q₁, in the ninth example is bounded, but it is not boundedly evaluable.

Query Q₂ of the ninth example is not bounded, and it does not have an envelope. This is not a coincidence. Boundedness is a necessary condition for a query to have an envelope in an embodiment, as described below.

Under an access schema A,

when a query Q has an (upper or lower) envelope, then Q must be bounded;

a CQ Q(x̅) is bounded when and only when all free variables x̅ of Q are covered by A; and

a query Q in ∃FO⁺ is bounded when and only when every CQ sub-query of Q is bounded.

For a boundedly evaluable query in ∃FO⁺, some of its CQ sub-queries may not be boundedly evaluable.

For a CQ Q that is not boundedly evaluable under A, UEP determines whether a Q may be covered by removing relation atoms, and hence removing variables that are not covered by A. For instance, query Q₁ of the ninth example has a relation atom R(y,w) with variable y that is not covered. When R (y,w) is removed, an upper envelope Qᵤ that is covered remains.

When Q is in ∃FO⁺, UEP for ∃FO⁺ is described below, which can be verified based on the definitions of query relaxations and covered queries for ∃FO⁺.

Under an access schema A, a query Q in ∃FO⁺ has an upper envelope that is a relaxation and covered when and only when for each CQ sub-query Qᵢ of Q, either Qᵢ has a covered relaxation, or for any A-instance θ(T_{Q}) of Qᵢ, there exists a covered relaxation Q′ⱼ of a CQ sub-query Qⱼ such that θ(u)∈Q′ⱼ(θ(T_{Q})).

Complexity of UEP(L) is described. UEP(FO) in which an upper envelope Qᵤ is simply defined to be a boundedly evaluable FO query such that Q [symbol] _{A}Qᵤ and Qᵤ has a constant approximation bound with respect to Q.

While UEP is intractable for CQ and ∃FO⁺, its analyses are much simpler than their BEP counterparts in embodiments.

Under an access schema, UEP is

NP-complete for CQ;

Π₂^{p}-complete for UCQ and ∃FO⁺; and

undecidable for FO.

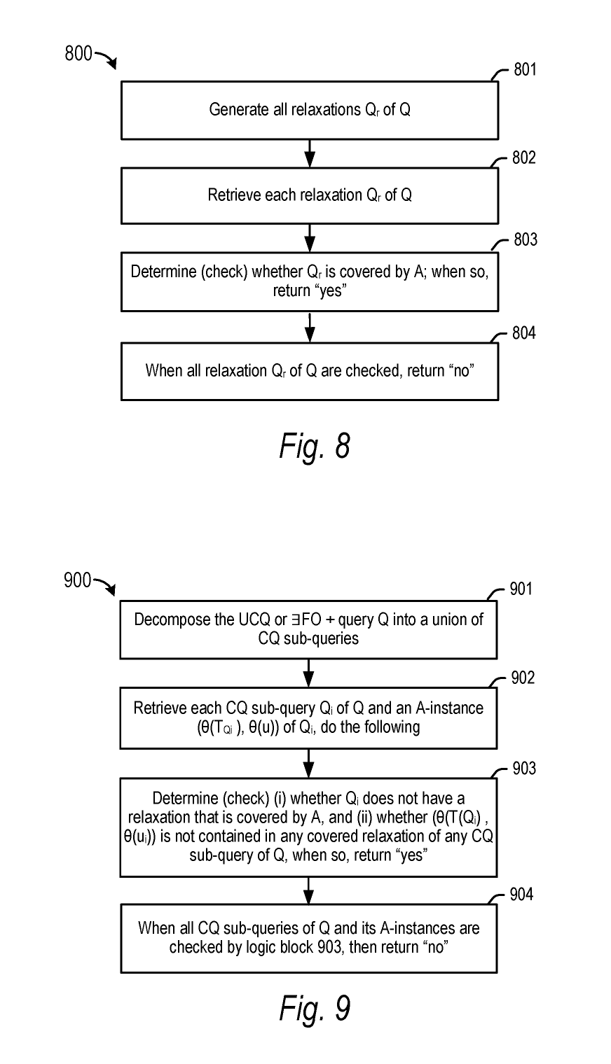

FIG. 8 is a flowchart that illustrates a method 800 to determine whether a bounded upper envelope approximation is available for a CQ according to embodiments of the present technology.

Logic block 801 illustrates generating all relaxations Qᵣ of query Q. In an embodiment, an envelope routine 1606a in FIG. 16 performs at least a portion of this function.

Logic block 802 illustrates retrieving each relaxation Qᵣ of query Q. In an embodiment, envelope routine 1606a in FIG. 16 performs at least a portion of this function.

Logic block 803 illustrates determining whether Qᵣ is covered by A and when so, returning “yes.” In an embodiment, envelope routine 1606a in FIG. 16 performs at least a portion of this function.

Logic block 804 illustrates when all relaxation Qᵣ of Q are checked, returning “no. In an embodiment, envelope routine 1606a in FIG. 16 performs at least a portion of this function.

FIG. 9 is a flowchart that illustrates a method 900 determining whether a bounded upper envelope approximation is available for a UCQ or ∃FO⁺ according to embodiments of the present technology.

Logic block 901 illustrates decomposing a UCQ or ∃FO⁺ query Q into a union of CQ sub-queries. In an embodiment, envelope routine 1606a in FIG. 16 performs at least a portion of this function.

Logic block 902 illustrates retrieving each CQ sub-query Qᵢ of Q and an A-instance (θ(T_{Qi}), θ(u)) of Qᵢ. In an embodiment, envelope routine 1606a in FIG. 16 performs at least a portion of this function.

Logic block 903 illustrates determining whether Qᵢ does not have a relaxation that is covered by A, and whether (θ(T(Qᵢ), θ(uᵢ)) is not contained in any covered relaxation of any CQ sub-query of Q. When so, a “yes” is returned. In an embodiment, envelope routine 1606a in FIG. 16 performs at least a portion of this function.

Logic block 904 illustrates when all CQ sub-query of Q and its A-instances are checked by logic block 903, then return “no”. In an embodiment, envelope routine 1606a in FIG. 16 performs at least a portion of this function.

### Determining Lower Envelopes

Similar to determining upper envelopes, lower envelopes of a certain syntactic form is described below.

For a positive integer k. A k-expansion of a CQ Q(x)=∃y̅ψ(x̅,y̅) is a CQ Q′(x̅)=∃y̅′ψ′(x̅,y̅′) such that y̅⊂y̅′, every atomic formula in ψ is an atomic formula in ψ′, and moreover, ψ′ contains at most k relation atoms that do not occur in ψ.

In other words, let (T_{Q},u) be the tableau representation of Q, and T′_{Q} be a tableau obtained by adding at most k additional tuples to T_{Q}. Then Q′ is a CQ represented by (T′_{Q}, u). For instance, query Qₗ given in ninth example is an 1-expansion of query Q₁. Observe that Q′⊂Q and Q′ [symbol] _{A}Q for any access schema A that is defined over the same relational schema R on which queries Q and Q′ are defined.

A k-expansion of a query Q in ∃FO⁺ may be defined to be a query Q′ in ∃FO⁺ such that each CQ sub-query of Q′ is a k-expansion of a CQ sub-query of Q.

A lower envelope problem for a query class L, denoted by LEP(L) is described below.

INPUT: R, A, and Q, as in UEP, and a natural number k.

QUESTION: Does there exist a lower envelope Qₗ of Q under A that is A-satisfiable? In particular, when L is CQ, UCQ or ∃FO⁺, it is to decide whether there exists a lower envelope Qₗ that is a k-expansion of Q and is covered by A. Qₗ is referred to as a k-expansion lower envelope.

In an embodiment, Qₗ is A-satisfiable to rule out “trivial” lower envelopes. When a CQ Q is bounded under A, empty query Q_{ø} would have been a lower envelope of Q. Such a trivial envelope may not very useful in embodiments. Such a condition on upper envelopes may not be used in an embodiment, since an upper envelope Qᵤ is guaranteed A-satisfiable. UEP is described for Q that is not boundedly evaluable under A. Hence, Q must be A-satisfiable. By Q [symbol] _{A}Qᵤ, Qᵤ is also A-satisfiable.

[symbol]

For a CQ Q that is not boundedly evaluable, LEP is to determine whether Q can be made covered by adding additional relation atoms. In other words, when Q contains variables that are not covered, relation atoms are added to make them covered, as illustrated by Qₗ in the above example. When Q contains relation atoms R(y̅) that are not indexed by A (see description of covered queries), in an embodiment R(y̅) may be “split” into R (y̅₁) [symbol] . . . [symbol] R(y̅ₙ) [symbol] such that y̅=(y̅₁, . . . , y̅ₙ) and each R(y̅ᵢ) is indexed.

In a tenth example, consider a relation schema R(A,B,C), an access schema A, and a CQ Q defined as follows:

A={R(A→B,N),R(B→C,1)},Q(x,y)=R(1,x,y).

Then Q is not covered by A, since R(1,x,y) is not indexed by A Nonetheless, its 1-expansion below is covered:

Q′(x,y)=∃z₁,z₂(R(1,x,z₁) [symbol] R(z₂,x,y)).

One can verify that Q′ is indexed and Q′≡_{A} Q.

For query Q in ∃FO⁺, a characterization for the existence of lower envelopes is described below, which can be verified by using the definitions of covered queries and k-expansions.

Under an access schema A, a query Q in ∃FO⁺ has a k-expansion lower envelope when and only when Q is bounded under A, and there exists a CQ sub-query Qᵢ of Q such that it has a k-expansion that is covered by A and is A-satisfiable.

Compared to UEP(L), LEP(L) has a lower complexity when L is UCQ or ∃FO⁺ as described below.

Under an access schema A, LEP is

NP-complete for CQ and UCQ;

DP-complete for ∃FO⁺; and

Undecidable for FO.

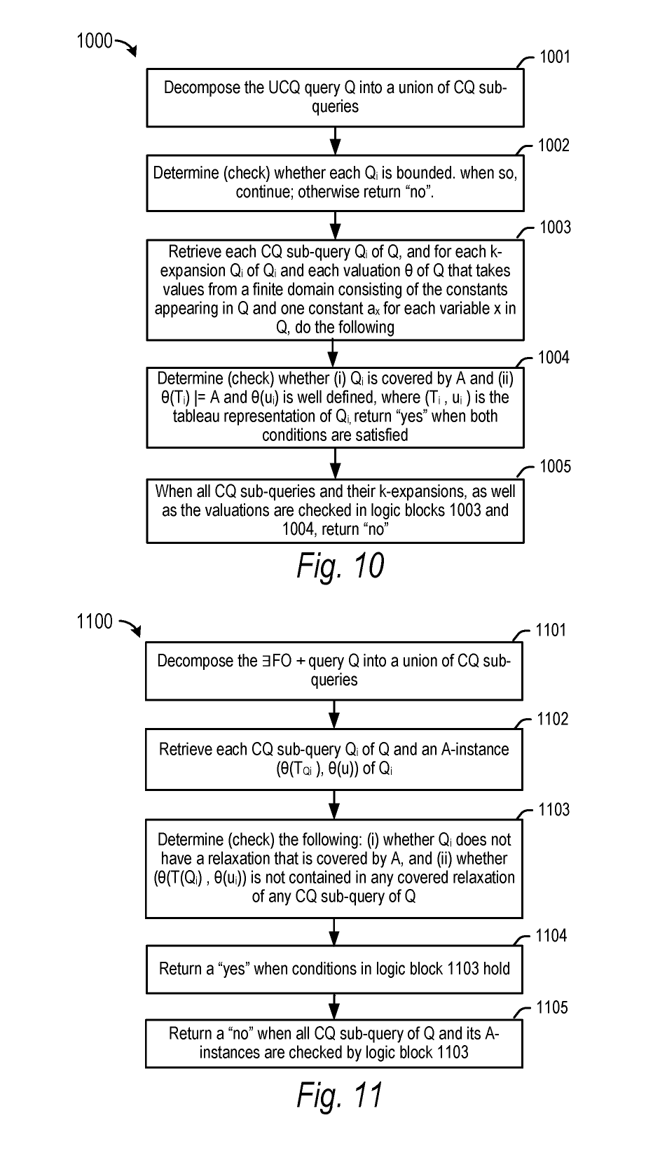

FIG. 10 is a flowchart that illustrates a method 1000 determining whether a bounded lower envelope approximation is available for a CQ or UCQ according to embodiments of the present technology.

Logic block 1001 illustrates decomposing a UCQ query Q into a union of CQ sub-queries. In an embodiment, the envelope routine 1606a in FIG. 16 performs at least a portion of this function.

Logic block 1002 illustrates determining whether each Qᵢ is bounded. When so, continue; otherwise return “no”. In an embodiment, envelope routine 1606a in FIG. 16 performs at least a portion of this function.

Logic block 1003 illustrates retrieving each CQ sub-query Qᵢ of Q, and for each k-expansion Qᵢ of Qᵢ and each valuation θ of Q that takes values from a finite domain consisting of the constants appearing in Q and one constant ax for each variable x in Q. In an embodiment, envelope routine 1606a in FIG. 16 performs at least a portion of this function.

Logic block 1004 illustrates determining whether Qᵢ is covered by A and θ(Tᵢ)|=A and θ (uᵢ) is well defined, where (Tᵢ, uᵢ) is the tableau representation of Qᵢ, and return “yes” when both conditions are satisfied. In an embodiment, envelope routine 1606a in FIG. 16 performs at least a portion of this function.

Logic block 1005 illustrates when all CQ sub-queries and their k-expansions, as well as the valuations are determined in logic blocks 1003 and 1004, return “no”. In an embodiment, envelope routine 1606a, as shown in FIG. 16, executed by one or more processors, such as processor 1510 shown in FIG. 15, performs at least a portion of this function in an embodiment.

FIG. 11 is a flowchart that illustrates a method 1100 determining whether a bounded lower envelope approximation may be determined for a ∃FO⁺ according to embodiments of the present technology.

Logic block 1101 illustrates decomposing a ∃FO⁺ query Q into a union of CQ sub-queries. In an embodiment, the envelope routine 1606a in FIG. 16 performs at least a portion of this function.

Logic block 1102 illustrates retrieving each CQ sub-query Qᵢ of Q and an A-instance (θ(T_{Qi}), θ(u)) of Qᵢ. In an embodiment, envelope routine 1606a in FIG. 16 performs at least a portion of this function.

Logic block 1103 illustrates determining whether Qᵢ does not have a relaxation that is covered by A, and whether (θ(T(Qᵢ), θ(uᵢ)) is not contained in any covered relaxation of any CQ sub-query of Q). In an embodiment, the envelope routine 1606a in FIG. 16 performs at least a portion of this function.

Logic block 1104 illustrates returning a “yes” when conditions in logic block 1103 hold. In an embodiment, the envelope routine 1606a in FIG. 16 performs at least a portion of this function.

Logic block 1105 illustrates returning a “no” when all CQ sub-query of Q and its A-instances are checked by logic block 1103. In an embodiment, the envelope routine 1606a in FIG. 16 performs at least a portion of this function.

### Bounded Query Specialization

For a query Q that is not boundedly evaluable, the query Q may become boundedly evaluable when a user instantiates some parameters of Q in an embodiment. Paramaterized queries are typical in e-commerce systems and personalized searches, and such queries are typically specialized by instantiating some of the queries parameters when being issued by a user. A query specialization problem, denoted as QSP, is described below.

### Query Specialization

Consider Q(y̅)=∃z̅ψ(y̅,z̅) in CQ, where ψ is quantifier free, and z̅ consists of bound variables. Parameters of Q, denoted by X, may include both free variables of y̅ and bound variables of z̅. Such parameters are typically designated by a user or provider of Q.

A specialized query Q(x̅=c̅) of Q is defined as ∃z̅(ψ(y̅,z̅) [symbol] x̅=c̅) in an embodiment, where x̅ is a tuple of parameters in X, and c̅ is a tuple of constants with |x̅|=|c̅|. Here, |x̅| is used to denote the arity of x̅, and refer to c̅ as a valuation of x̅. In other words, Q is specialized by instantiating parameters x̅.

For a tenth example, consider query Q defined on relations Accident, Casualty, and Vehicle, as described in the first example:

Q(xₐ)=∃ aid, date, district, cid, class, vid, dri

(Accident (aid, distict, aid) [symbol] Casualty (cid, aid, class, vid) [symbol] Vehicle(vid, dri, xₐ)).

It has two parameters, date and district in X, identified by a provider of Q. For a valuation (c₁,c₂) of (date, district), the specialized query Q(date=c₁,district=c₂) of Q is to find the ages of drivers who were involved in an accident in district c₂ on day C₁. For instance, Q(date=“1/5/2005”, district=“Queen's Park”) is query Q₀ in the first example.

Under access constraints ψ₁-ψ₄ in the first example, (1) Q is not boundedly evaluable itself, since free variable xₐ is not covered; but (2) Q(date=c₁) is boundedly evaluable for all valuations c₁ of date; i.e., instantiating a single parameter makes the specialized queries boundedly evaluable.

For an FO query Q, consider its DNF form: Q(y̅)=P₁z₁ . . . Pₙ,zₙ,ψ(y̅,z̅), where Pᵢ is either ∃ or ∀, and z̅ denotes (z₁, . . . , zₙ). Its parameters in X may be variables from y̅ and x̅. A specialized query Q(x̅=c̅) of Q is defined as P₁z₁ . . . Pₙ,zₙ(ψ)(y̅,z̅) [symbol] x̅=c̅) in an embodiment, where x̅ is a tuple of parameters in X, and c̅ is a valuation of x̅.

Consider query Q that is not boundedly evaluable under an access schema A, with a parameter set X. Q may be boundedly specialized under A with x̅ when x̅ is a tuple of parameters from X such that Q(x̅=c̅) is boundedly evaluable under A for all valuations c̅ of x̅, and there exists at least one valuation c̅ of x̅ such that Q(x̅=c̅) is A-satisfiable.

In other words, the first condition requires for Q(x̅=c̅) to be generic regardless of what valuations are used, and the second condition requires the specialized query to be sensible in embodiments.

Some queries Q may not be boundedly specialized. For instance, query Q from the tenth example. When its set X of parameters consists of district only, one can verify that Q may not be boundedly specialized under constraints ψ₁-ψ₄. Moreover, when Q can be boundedly instantiated, a minimum set of parameters in X may be instantiated in embodiments.

A query specialization problem, denoted by QSP(L) for a query language L, is described below.

INPUT: A relational schema R, an access schema A over R, a query Q∈L defined over R that is not boundedly evaluable under A, a set X of parameters in Q, and a natural number k.

QUESTION: Can Q be boundedly specialized under A with a tuple x̅ from X such that |x̅|≦k? In particular, when L is CQ, UCQ or ∃FO⁺, determine whether there exists x̅ such that |x̅|≦k and Q(x̅=c̅) is covered by A for all valuations c̅ of x̅.

A QSP aids in determining what access schema to maintain and what parameters to instantiate, to make specialized queries boundedly evaluable.

When L is CQ, UCQ or ∃FO⁺, specialized queries Q(x̅=c̅) that are covered by A are preferred, to reduce the cost of a QSP determination in an embodiment. Q(x̅=c̅) is boundedly evaluable under A. Without the syntactic restriction, QSP(L) has complexity higher than BEP(L) when L is, e.g., CQ, and is too costly to be practical in an embodiment.

Both QSP and LEP determinations aim to restrict a query Q and make it boundedly evaluable. However, QSP approaches bounded evaluability by instantiating parameters, while LEP is approached by imposing additional relation atoms on Q. Moreover, LEP requires that |Q(D)−Qₗ(D)|≦Nₗ with a constant Nₗ for all instances D that satisfy A. In light of this, Q has to be bounded to get a lower envelope, whereas this is not required by QSP in embodiments. As described below, QSP(L) and LEP(L) have different complexity for UCQ and ∃FO⁺.

### Determining Bounded Specialization

Complexity of QSP(L) is described below. It is nontrivial to identify parameters x̅ of Q for instantiation and make specialized Q(x̅=c̅) boundedly evaluable.

For example, consider a relational schema R, an access schema A, and a CQ Q over R: (1) R consists of Rᵢ(A, B₁, B₂, B₃) for i∈[1,n], (2) A defines 4 constraints on each Rᵢ: Rᵢ(A→(B₁, B₂, B₃), 1), Rᵢ(B₁→A, 1), Rᵢ(B₂→A, 1) and Rᵢ(B₃→A, 1); and (3) Q is:

∃y̅,z̅( [symbol] _{i∈[1,n]}Rᵢ(1,1,1,1) [symbol] [symbol] _{i∈[1,n]}Rᵢ(yᵢzᵢ₁,zᵢ₂,zᵢ₃)).

A Boolean query Q( ), that is not boundedly evaluable under A, may be verified. In this example, let X be y̅ and k be a positive integer. Q may be boundedly specialized with x̅ from X and |x̅|≦k in embodiments.

Complexity of QSP is

NP-complete for CQ;

Π₂^{p}-complete for UCQ and ∃FO⁺; and

undecidable for FO.

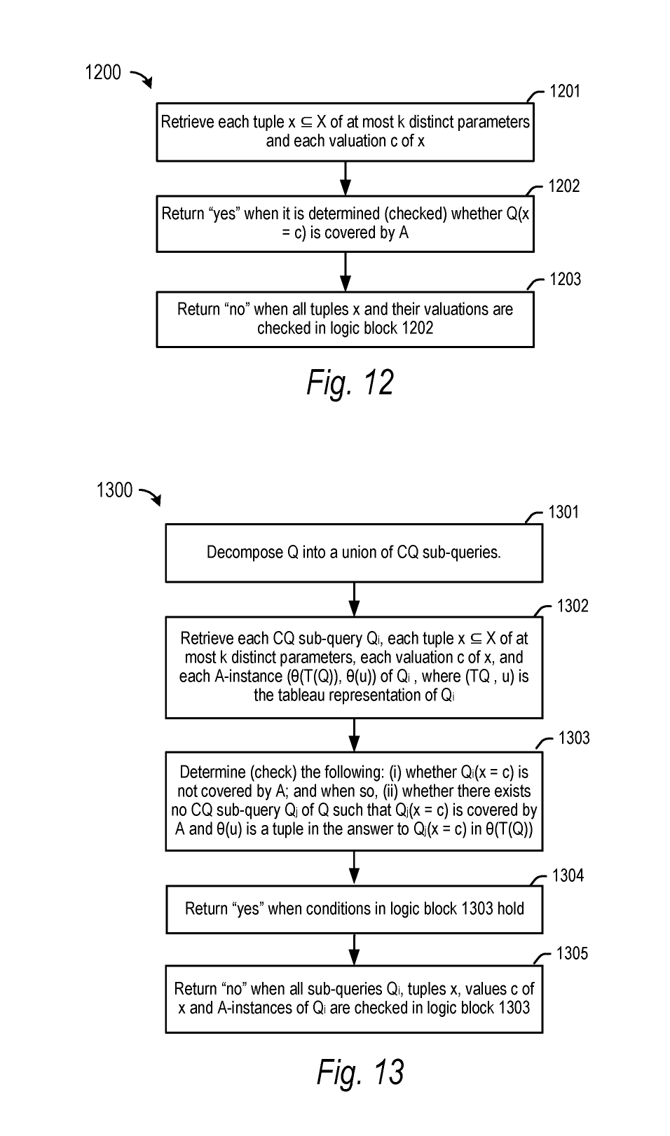

FIG. 12 is a flowchart that illustrates a method 1200 determining whether a bounded query specialization query may be determined for a CQ according to embodiments of the present technology.

Logic block 1201 illustrates retrieving each tuple x⊂X of at most k distinct parameters and each valuation c of x. In an embodiment, the specialization routine 1606b in FIG. 16 performs at least a portion of this function.

Logic block 1202 illustrates returning “yes” when it is determined that Q(x=c) is covered by A. In an embodiment, the specialization routine 1606b in FIG. 16 performs at least a portion of this function.

Logic block 1203 illustrates returning “no” when all tuples x and their valuations are checked in logic block 1202. In an embodiment, the specialization routine 1606b in FIG. 16 performs at least a portion of this function.

FIG. 13 is a flowchart that illustrates a method 1300 of determining whether a bounded query specialization query may be determined for a UCQ or ∃FO⁺ according to embodiments of the present technology.

Logic block 1301 illustrates decomposing query Q into a union of CQ sub-queries. In an embodiment, the specialization routine 1606b in FIG. 16 performs at least a portion of this function.

Logic block 1302 illustrates retrieving each CQ sub-query Qᵢ, each tuple x⊂X of at most k distinct parameters, each valuation c of x, and each A-instance (θ(T(Q)), θ(u)) of Qᵢ where (TQ, u) is the tableau representation of Qᵢ. In an embodiment, the specialization routine 1606b in FIG. 16 performs at least a portion of this function.

Logic block 1303 illustrates determining whether Qᵢ(x=c) is not covered by A; and when so, whether there exists no CQ sub-query Qⱼ of Q such that Qⱼ(x=c) is covered by A and θ(u) is a tuple in the answer to Qⱼ(x=c) in θ(T(Q)). In an embodiment, the specialization routine 1606b in FIG. 16 performs at least a portion of this function.

Logic block 1304 illustrates returning “yes” when conditions in logic block 1303 hold. In an embodiment, the specialization routine 1606b in FIG. 16 performs at least a portion of this function.

Logic block 1305 illustrates returning “no” when all sub-queries Qᵢ, tuples x, values c of x and A-instances of Qᵢ are checked in logic block 1303. In an embodiment, envelope routine 1606a in FIG. 16 performs at least a portion of this function.

FIG. 14 is a high-level block diagram of a system (or apparatus) 1400 for retrieving information (or answer) 1431, in response to query 1430, from database (or dataset) 1403 that may include big data. System 1400 includes both hardware and software components in an embodiment. In an embodiment, system 1400 includes a plurality of computing devices (such as computers) 1410-1412 that are coupled to a network 1420. In embodiments, computing device 1410 is a laptop computing device and computing device 1411 is a cellular telephone (or smartphone). In an embodiment, computing device 1412 is embodied as a server. In other embodiments, more or fewer types of computing devices may be used. Types of computing device may include, but not limited to, wearable, personal digital assistant, cellular telephones, tablet, netbook, laptop, desktop, embedded and/or mainframe.

A user 1421 may use a computing device, such as computing devices 1410 and 1411, to submit a query 1430 to computing device 1412 via network 1420 in order to retrieve information 1431 from database 1430. In an embodiment, database 1430 is a software component that stores big data. In an embodiment, information 1431 is a bounded amount of information or data. In an embodiment, the bounded evaluable routine 1402 is a software component having computer instructions executed by computing device 1412 to retrieve information 1431 in response to query 1430. In embodiments, the bounded evaluable routine 1402, among other functions as described herein, determines whether query 1430 is bounded evaluable under a set of access constraints and forms a query plan to obtain information 1431. Bounded evaluable 1402 may also provide approximate information to query 1430. Information 1431 is provided to computing device 1410 via network 1420 in response to computing device 1412 receiving query 1430.

In embodiments, functions described herein are distributed to other or more computing devices. In an embodiment, database 1403 may be included in a separate computing device than computing device 1412 and may be accessible by computing device 1412 via network 1420. In an embodiment, database 1403 may be included in multiple computing devices. In embodiments, one or more computing devices illustrated in FIG. 14 may act as a server that provides a service, while one or more computing devices may act as a client. In an embodiment, one or more computing devices may act as peers in a peer-to-peer (P2P) relationship.

In embodiments, computing devices 1410-1412 may include one or more processors to read and/or execute computer instructions stored on a non-transitory computer-readable storage medium to provide at least some of the functions describe herein. For example, computing devices 1410-1412 may have user interfaces as described herein to communicate with the respective computing devices. Further, computing devices 1410-1411 may submit queries to computing device 1412 while computing device 1412 responds to the submitted queries with information from database 1403.

Computing devices 1410-1412 communicate or transfer information by way of network 1420. In an embodiment, network 1420 may be wired or wireless, singly or in combination. In an embodiment, network 1420 may be the Internet, a wide area network (WAN) or a local area network (LAN), singly or in combination. In an embodiment, network 1420 may include a High Speed Packet Access (HSPA) network, or other suitable wireless systems, such as for example Wireless Local Area Network (WLAN) or Wi-Fi (Institute of Electrical and Electronics Engineers' (IEEE) 802.11x). In an embodiment, computing devices 1410-1412 use one or more protocols to transfer information or packets, such as Transmission Control Protocol/Internet Protocol (TCP/IP). In embodiments, computing devices 1410-1412 include input/output (I/O) computer-readable instructions as well as hardware components, such as I/O circuits to receive and output information from and to other computing devices, via network 1420. In an embodiment, an I/O circuit may include at least a transmitter and receiver circuit.

FIG. 15 illustrates a hardware architecture 1500 for executing the bounded evaluable routine 1402. In particular, hardware architecture 1500 illustrates a computing device 1412 that may be a server to provide information 1431 to a query 1430 in an embodiment. Computing device 1412 may be implemented in various embodiments. Computing devices may utilize all of the hardware and software components shown, or a subset of the components in embodiments. Levels of integration may vary depending on an embodiment. For example, memory 1520 and 1530 may be combined into a single memory or divided into many more memories. Furthermore, a computing device 1412 may contain multiple instances of a component, such as multiple processors (cores), memories, databases, transmitters, receivers, etc. Computing device 1412 may comprise a processor equipped with one or more input/output devices, such as network interfaces, storage interfaces, and the like. Computing device 1412 may include a processor 1510, a memory 1520 to store the bounded evaluable routine 1402, a memory 1530 to store database 1403, a user interface 1560 and network interface 1550 coupled by a interconnect 1570. Interconnect 1570 may include a bus for transferring signals having one or more type of architectures, such as a memory bus, memory controller, a peripheral bus or the like.

In an embodiment, processor 1510 may include one or more types of electronic processors having one or more cores. In an embodiment, processor 1510 is an integrated circuit processor that executes (or reads) computer instructions that may be included in code and/or software programs. In an embodiment, processor 1510 is a digital signal processor, baseband circuit, field programmable gate array, digital logic circuit and/or equivalent.

In embodiments, memory 1520 and 1530 may include non-transitory memory storage configured to store instructions.

For example, memory 1520 may comprise any type of system memory such as static random access memory (SRAM), dynamic random access memory (DRAM), synchronous DRAM (SDRAM), read-only memory (ROM), a combination thereof, or the like. In an embodiment, a memory 1520 may include ROM for use at boot-up, and DRAM for program and data storage for use while executing instructions, such as the bounded evaluable routine 1402. In embodiments, memory 1520 is non-transitory or non-volatile integrated circuit memory storage.

Memory 1530 may comprise any type of memory storage device configured to store data, software programs including instructions, and other information and to make the data, software programs, and other information accessible via interconnect 1570. Memory 1530 may comprise, for example, one or more of a solid state drive, hard disk drive, a magnetic disk drive, an optical disk drive, or the like. In an embodiment, memory 1530 stores database 1403 that may include big data. In embodiments, memory 1530 is non-transitory or non-volatile integrated circuit memory storage.

Computing device 1412 also includes one or more network interfaces 1550, which may comprise wired links, such as an Ethernet cable or the like, and/or wireless links to access network 1420. A network interface 1550 allows computing device 1412 to communicate with remote computing devices via the networks 1420. For example, a network interface 1550 may provide wireless communication via one or more transmitters/transmit antennas and one or more receivers/receive antennas.

User interface 1560 may include computer instructions as well as hardware components in embodiments. A user interface 1560 may include input devices such as a touchscreen, microphone, camera, keyboard, mouse, pointing device and/or position sensors. Similarly, a user interface 1560 may include output devices, such as a display, vibrator and/or speaker, to output images, characters, vibrations, speech and/or video as an output. A user interface 1560 may also include a natural user interface where a user may speak, touch or gesture to provide input.

FIG. 16 illustrates a software architecture 1600 of the bounded evaluable routine 1402. Software architecture 1600 illustrates software components having computer instructions to at least provide bounded information in big data in response to a query. In embodiments, software components illustrated in FIG. 16 may be embodied as a software program, software object, software function, software subroutine, software method, software instance, script and/or a code fragment, singly or in combination. In order to clearly describe the technology, software components shown in FIG. 16 are described as individual components. In embodiments, the software components illustrated in FIG. 16, singly or in combination, may be stored (in single or distributed computer-readable storage medium(s)) and/or executed by a single or distributed computing device (processor) architecture. Functions performed by the various software components described herein are exemplary. In other embodiments, software components identified herein may perform more or less functions.

In an embodiment, the bounded evaluable routine 1402 is a software component that includes or communicates with the following software components: the I/O routine 1601, the determine type of query routine 1602, the determine bounded evaluable routine 1603, the query plan routine 1604, the rewrite query routine 1605 and an approximate routine 1605 (including an envelope routine 1606a and a specialization routine 1606b).

The I/O routine 1601 is responsible for, among other functions, receiving a query, such as query 1430 and outputting information from a database, such as information 1431 shown in FIG. 14 in an embodiment. In embodiments, the I/O routine 1601 may output other information, such as indicating that a “Query in not bounded evaluable,” a query plan that may be used to obtain information 1431, a rewritten query, an approximate answer to a query and/or an indication that a query does not have an approximate answer.

The determine type of query routine 1602 is responsible for, among other functions, determining a type or class of query in an embodiment. In an embodiment, the determine type of query routine 1602 determines a query type that is received by the I/O routine 1601. In an embodiment, the determine type of query routine 1602 determines whether a query is a including a conjunctive query (CQ), union of conjunctive queries (UCQ), or a positive existential FO (first order) conjunctive query (∃FO⁺). In an embodiment, type of query 1602 indicates the type of query to the determine bounded evaluable routine 1603.

The determine bounded evaluable routine 1603 is responsible for, among other functions, determining whether a query of a particular type is bounded evaluable, in an embodiment. In an embodiment, the determine bounded evaluable routine 1603 receives a query to be evaluated or analyzed from the I/O routine 1601 and a determined query type from the determine type of query routine 1602. In an embodiment, the determine bounded evaluable routine 1603 determines BEP of a received query. In an embodiment, the determine bounded evaluable routine 1603 determines whether the received query having a particular type is covered by a particular access schema A. In still a further embodiment, the determine bounded evaluable routine 1603 determines whether a received query of a particular type has covered variables. In yet another embodiment, the determine bounded evaluable routine 1603 determines whether a received query is a covered query.

The query plan routine 1604 is responsible for, among other functions, forming a query plan for a received query in an embodiment. In an embodiment, the query plan routine 1604 forms a query plan when the determine bounded evaluable routine 1603 indicates that a received query is bounded evaluable. In an embodiment, the query plan routine 1604 provides a query plan to rewrite query routine 1605.

Rewrite query routine 1605 is responsible for, among other functions, rewriting a received query to retrieve bounded information into a rewritten or another query that may retrieve the same bounded information, such as information 1431. In an embodiment, rewrite query routine 1605 rewrites a received query in response to a query plan provided by the query plan routine 1604. In an embodiment, rewrite query routine 1605 provides one or more rewritten queries to the I/O routine 1601, and the I/O routine 1601 forwards the rewritten query to retrieve information from a dataset.

The approximate routine 1606, including envelope routine 1606a and the specialization routine 1606b, is responsible for, among other functions, determining whether an approximate answer or information to a received query may be obtained in an embodiment. Envelope routine 1606a determines whether bounded upper and bounded lower approximate answers may be determined in embodiment. In an embodiment, the specialization routine 1606b is responsible for determining whether a received query may have an approximate answer by instantiating a parameter value in the received query. In an embodiment, the approximate routine 1606 calculates an approximate answer to a received query from the I/O routine 1601 and returns an approximate answer to the I/O routine 1601 for forwarding to a user and/or requesting computing device. In an embodiment, the approximate routine 1606 provides an indication that an approximation is not available to the I/O routine 1601 for forwarding to a user and/or requesting computing device.

The flowcharts and block diagrams in the figures illustrate the architecture, functionality, and operation of possible implementations of a device, apparatus, system, computer-readable medium and method according to various aspects of the present disclosure. In this regard, each block (or arrow) in the flowcharts or block diagrams may represent operations of a system component, software component or hardware component for implementing the specified logical function(s). It should also be noted that, in some alternative implementations, the functions noted in the block may occur out of the order noted in the figures. For example, two blocks (or arrows) shown in succession may, in fact, be executed substantially concurrently, or the blocks (or arrows) may sometimes be executed in the reverse order, depending upon the functionality involved. It will also be noted that each block (or arrow) of the block diagrams and/or flowchart illustration, and combinations of blocks (or arrows) in the block diagram and/or flowchart illustration, can be implemented by special purpose hardware-based systems that perform the specified functions or acts, or combinations of special purpose hardware and computer instructions.

It will be understood that each block (or arrow) of the flowchart illustrations and/or block diagrams, and combinations of blocks (or arrows) in the flowchart illustrations and/or block diagrams, may be implemented by non-transitory computer instructions. These computer instructions may be provided to and executed (or read) by a processor of a general purpose computer (or computing device), special purpose computer, or other programmable data processing apparatus to produce a machine, such that the instructions executed via the processor, create a mechanism for implementing the functions/acts specified in the flowcharts and/or block diagrams.

As described herein, aspects of the present disclosure may take the form of at least a device having a one or more processors executing instrucionts stored in non-transitory memory storage, a computer-implemented method, and/or non-transitory computer-readable storage medium storing computer instructions.

Non-transitory computer-readable media includes all types of computer readable media, including magnetic storage media, optical storage media, and solid state storage media and specifically excludes signals. It should be understood that software including computer instructions can be installed in and sold with a computing device having computer-readable storage media. Alternatively, software can be obtained and loaded into a computing device, including obtaining the software via a disc medium or from any manner of network or distribution system, including, for example, from a server owned by a software creator or from a server not owned but used by the software creator. The software can be stored on a server for distribution over the Internet, for example.

More specific examples of the computer-readable storage medium include ta portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing.

Non-transitory computer instructions for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The computer instructions may execute entirely on the user's computer (or computing device), partly on the user's computer, as a stand-alone software package, partly on the user's computer and partly on a remote computer or entirely on the remote computer or server. In the latter scenario, the remote computer may be connected to the user's computer through any type of network, or the connection may be made to an external computer (for example, through the Internet using an Internet Service Provider) or in a cloud computing environment or offered as a service such as a Software as a Service (SaaS).

The description of the present disclosure has been presented for purposes of illustration and description, but is not intended to be exhaustive or limited to the disclosure in the form disclosed. Many modifications and variations will be apparent without departing from the scope and spirit of the disclosure. The aspects of the disclosure herein were chosen and described in order to best explain the principles of the disclosure and the practical application, and to enable others to understand the disclosure with various modifications as are suited to the particular use contemplated.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device, comprising:
a non-transitory memory storage comprising instructions; and
one or more processors in communication with the memory, wherein the one or more processors execute the instructions to:
receive a query having a set of access constraints to retrieve information,
determine a query type of the query,
determine whether the query is bounded evaluable under the set of access constraints,
form a query plan to retrieve the information when the query is bounded evaluable under the set of access constraints,
rewrite the query to a rewritten query using the query plan, and
retrieve the information in response to the rewritten query.

2. The device of claim 1, wherein the set of access constraints include indices and cardinality constraints, and wherein an amount of time to retrieve the information is dependent on the query and the set of access constraints and not dependent on a size of the dataset.

3. The device of claim 1, wherein the one or more processors execute the instructions to approximate an answer to the query when the query is not bounded evaluable.

4. The device of claim 3, wherein the one or more processors execute the instructions to approximate an answer to the query by forming an upper envelope answer and a lower envelope answer.

5. The device of claim 3, wherein the query includes a variable, and wherein the one or more processors execute the instructions to approximate an answer to the query by instantiating the variable in the query.

6. The device of claim 1, wherein the query type comprises a conjunctive query (CQ), an union of conjunctive queries (UCQ), or a positive existential first order (FO) conjunctive query (∃FO⁺).

7. The device of claim 6, wherein the query type is the CQ type, wherein the one or more processors execute the instructions to determine whether the query to retrieve information is bounded evaluable includes:
calculate cov(Q, A); determine variables in cov (Q, A) that are covered;
determine variables that are not in cov (Q,A); and
determine for each atom of the query that there is a particular access constraint.

8. The device of claim 6, wherein the query type is the UCQ type or the ∃FO⁺ type, wherein the one or more processors execute the instructions to:
decompose the query into a union of CQ sub-queries; retrieve each CQ sub-query Qᵢ of the query and an A-instance (θ(T_{Qi}), θ(u)) of Qᵢ; and
determine whether Qᵢ is not covered by A and whether θ(u) cannot be returned by any CQ sub-query of the query that is covered by A.

9. The device of claim 6, wherein the one or more processors execute the instructions to form the query plan to retrieve the information when the query is bounded evaluable under the set of access constraints includes:
retrieve values for each covered variable in cov (Q,\A) via a sub-query plan; and
combine values to variables into relations via a combination plan.

10. The device of claim 4, wherein the one or more processors execute the instructions to approximate the answer to the query by forming the upper and lower envelope answers includes: determine whether an upper envelope answer is obtainable; and determine whether the lower envelope answer is obtainable.

11. The device of claim 5, wherein the one or more processors execute the instructions to approximate the answer to the query by instantiating the variable in the query includes: determine whether the answer to the query is obtainable.

12. A computer-implemented method for retrieving data, comprising:
receiving, with one or more processors, a first query to retrieve the data from a dataset;
determining, with the one or more processors, a set of access constraints in the first query;
determining, with the one or more processors, indices in the set of access constraints in the first query;
forming, with the one or more processors, a second query based on the indices in the first query; and
outputting, with the one or more processors, the second query to obtain the data.

13. The computer-implemented method of claim 12, comprising:
determining, with the one or more processors, whether the second query may be formed that will retrieve the data.

14. The computer-implemented method of claim 13, comprising:
determining, with the one or more processors, whether an approximate data to the first query is available when the second query may not be formed.

15. The computer-implemented method of claim 14, wherein determining whether the approximate data to the first query is available comprises:
determining, with the one or more processors, whether an upper and lower envelope approximate data to the first query is available.

16. The computer-implemented method of claim 14, wherein determining whether the approximate data to the first query is available comprises:
determining, with one or more processors, whether the first query has a parameter that may be instantiated to provide approximate data.

17. A non-transitory computer-readable medium storing computer instructions, that when executed by one or more processors, cause the one or more processors to perform the steps of:
receive a query having a set of access constraints to retrieve information from a dataset;
determine whether the query is bounded evaluable under the set of access constraints;
rewrite the query to a rewritten query using at least one access constraint in the set of access constraints when the query is bounded evaluable;
output the rewritten query to retrieve the information; and
determine whether approximate information may be obtained when the query is not bounded evaluable.

18. The non-transitory computer-readable medium of claim 17, comprising the steps of:
determine a query type of the query,
wherein rewriting the query to the rewritten query depends on the query type.

19. The non-transitory computer-readable medium of claim 18, wherein the query type comprises a conjunctive query (CQ), an union of conjunctive queries (UCQ), or positive existential FO (first order) conjunctive query (∃FO⁺).

20. The non-transitory computer-readable medium of claim 19, wherein the set of access constraints include indices and cardinality constraints, and wherein an amount of time to retrieve the information is dependent on the query and the set of access constraints and not dependent on a size of the dataset.
